(19) United States
(12) Patent Application Publication
(10) Pub. No.: US 2026/0193404 A1
(43) Pub. Date: Jul. 9, 2026

(54) Polyester Polyols and Polyurethanes

(71) Applicant: Loop CO2, Inc., Marlborough, MA (US)

(72) Inventors: Hsin-Chun Chiu, Shrewsbury, MA (US); Liyuan Wang, Brookline, MA (US)

(21) Appl. No.: 19/443,851

(22) Filed: Jan. 8, 2026

Related U.S. Application Data
(60) Provisional application No. 63/743,179, filed on Jan. 8, 2025.

(51) Int. Cl. C08G 18/68; C08G 18/24; C08G 18/73; C08G 18/76; C08L 75/14; C09D 175/14; C09J 175/14

(52) U.S. Cl. CPC C08G 18/68; C08G 18/244; C08G 18/73; C08G 18/7671; C08L 75/14; C09D 175/14; C09J 175/14

(57) ABSTRACT

The present invention provides polyester polyols, polyurethanes, processes for producing these, and products prepared from these. The polyester polyols and their derivatives sequester carbon obtained from carbon dioxide. The wide variety of polyester polyols and polyurethanes provide flexibility to design and make products incorporating CO₂ that have properties tailored to numerous applications from shoes to coatings to insulation and more.

### RELATED APPLICATIONS

This application claims the priority benefit of U.S. patent application Ser. No. 63/743,179, filed 8 Jan. 2025.

### INTRODUCTION

Polyester polyols are commonly used intermediates for the manufacture of polyurethane products such as flexible and rigid polymeric foams, polyisocyanurate foams, coatings, sealants, adhesives, surfactants, and thermoplastic elastomers.

Rigid polyurethane (PU) foams play a major role in energy savings when used as efficient insulating panels in construction or in household items such as refrigerators or coolers. Flexible PU foams are used as comfort materials, e.g., mattresses, sofas, armchairs, car seats, shoes, synthetic leather, etc., but are also used for sound insulation and shock protection. Polyurethanes are the sixth largest family of polymers with a global market valued at approximately US$91 billion in 2024 and an annual growth rate of more than 6%.

Polyurethanes are typically derived from the reaction between the hydroxyl groups of polyester polyols with the isocyanate groups of an isocyanate or polyisocyanate. Recent efforts have focused on making more sustainable polyurethanes from bio-based feedstocks such as plant oils, but these sacrifice desirable properties and require other changes to achieve acceptable performance.

The present invention relates to renewable polyester-polyols and polyurethanes derived therefrom with an excellent and adjustable balance of mechanical properties such as strength, flexibility, elasticity, molding operability, etc., which are useful for a wide range of applications.

More sustainable polyurethane foams that incorporate CO₂ can be produced from polycarbonate polyols made by reacting CO₂ with epoxides as described in US 2011/0230580. However, the required epoxides are made by conventional methods that suffer from poor selectivity, high energy intensity, environmentally damaging by-products, and/or poor economics, making them less than desirable as starting materials. The polycarbonate polyols are difficult to use due to their high crystallinity that leads to high viscosity and low solubility. As a result, these materials must be blended with traditional polyether or polyester polyols to form useful polyurethanes as described in U.S. Pat. No. 11,021,564, such that less than half of the polyols that go into the polyurethane products incorporate CO₂. Moreover, recycling the blended polycarbonate polyurethanes is hindered by the presence of a large fraction of petroleum-derived materials.

In addition to developments in the CO₂-based polyol field, efforts to incorporate CO₂ into traditional polyether-based foams involve injection of CO₂ into the foam formulation. One approach has been to inject liquid CO₂ along with the polyol and isocyanate. This complicates the control of foam rigidity and uniformity, as the heat needed to overcome the cooling due to the endothermic CO₂ phase change cannot be uniformly applied due to the insulating nature of the developing foam; thus curing times are greatly increased.

In U.S. Pat. No. 10,619,000, Ohara discloses a process for making polyurethanes using polyester polyols derived from bio-derived diacids such as succinic acid, malic acid, tartaric acid, and citric acid, and diols such as ethylene glycol and 1,4 butanediol. The polyurethanes produced, however, do not incorporate CO₂, are rigid with low elongation, and the process is difficult to control.

Since its discovery in the 1970's, the product of the telomerization reaction of CO₂ with butadiene, 3-ethylidene-6-vinyltetrahydro-2H-pyran-2-one (EVP), has been identified as a leading candidate for the production of polymers incorporating CO₂. Attempts at conventional polymerization of EVP via a radical mechanism were less than promising, giving rise to complex mixtures. Ring-opening polymerization of EVP is not observed (Eagan, J. M., Macromol. Rapid Commun. 2022, 2200348). Dastgir in U.S. Pat. No. 11,312,677 disclosed derivatives that could be made from the delta-lactone produced when the vinyl group of EVP was selectively saturated (b in FIG. 1) and when EVP was completely saturated to yield 3,6-diethyltetrahydro-2H-pyran-2-one (DEtP), c in FIG. 1) using various high pressure hydrogenation systems, but did not disclose selective reduction of the vinylidene portion of EVP. In US 2024/0182633, Tonks disclosed the selective reduction of the vinylidene group in EVP to form 3-ethyl-6-vinyltetrahydro-2H-pyran-2-one (EtVP, a in FIG. 1), ring-opening polymerization (ROP) of EtVP to polyester polyols, and other reactions. While EtVP was shown to be an attractive intermediate for the formation of many materials, production of polyurethanes from EtVP was not reported.

Conventional polymers, including polyurethanes, are resistant to decomposition or degradation due to oils, water, sunlight, temperature, and microorganisms in the natural environment. While this is desirable for long-term applications, it presents a concern for their persistence in the environment when discarded or landfilled. Indeed, PUs need to be blended with easily biodegradable materials such as polylactic acid (PLA) or Polyhydroxyalkanoates (PHA) to accelerate their decomposition (Brzeska, J. et al, “Degradability of Polyurethanes and Their Blends with Polylactide, Chitosan and Starch”, Polymers 2021, 13, 1202). Nevertheless, a need exists to prepare PU structures that degrade more rapidly in the natural environment. Preferably, the used PU structures should be amenable to recycled to their starting materials for use in making fresh materials.

Therefore, there remains a need for strategies, processes, and formulations to incorporate CO₂ into useful and environmentally benign polyurethane compositions that can be easily recycled.

### Problem to be Solved

Polyurethanes formed by the condensation of conventional, petroleum-derived polyester polyols and polyisocyanates do little to achieve sustainability goals. Polycarbonate polyester polyols prepared from epoxides and CO₂ are highly crystalline, restricting their use in polyurethane production. Blending polycarbonate-derived polyurethanes with petroleum-based materials substantially reduces their contribution to achieving long-term carbon neutrality goals and introduces additional procedural complexities in recycling them to their original monomeric forms. The combination of sustainability concerns and operational inefficiencies underscores the need for innovative materials and processes with enhanced simplicity and compositional versatility for producing easily recycled polyurethanes incorporating CO₂. This invention discloses such versatile materials and processes.

It is an object of the present invention to disclose methods to produce polyester polyols incorporating CO₂ that do not require epoxides and achieve favorable polymer properties.

It is an object of the present invention to disclose methods to produce polyurethanes incorporating CO₂ that do not require epoxides, achieve favorable polymer properties, can be formulated without the addition of other polyols, and are easily recycled, compositions of these polyurethanes, processes for recycling the polyurethanes, and products produced from the polyurethanes or their recycled components.

### SUMMARY OF THE INVENTION

In one aspect, the invention provides a process for producing one or more polyester polyols, the process comprising the steps of: providing one or more lactones of Structure (2), wherein R2, R3, R4, and R5 are independently selected from H, alkyl, alkenyl, vinylidenyl, or aryl functional groups.

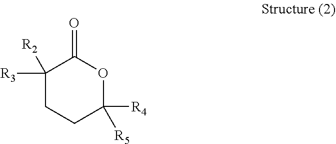

polymerizing the one or more lactones to form one or more polylactones, and reacting the polylactones with one or more polyols to form one or more polyester polyol(s).

In another aspect, the invention provides a process for producing one or more polyester polyols, the process comprising the steps of: a) providing one or more lactones of Structure (2), wherein R2, R3, R4, and R5 are independently selected from H, alkyl, alkenyl, vinylidenyl, or aryl functional groups, b) polymerizing the one or more of the lactones with one or more alcohols to form one or more polyester polyols, and, c) recovering the one or more polyester polyols.

Either of these aspects can be further characterized by one or any combination of the following: wherein one or more of the lactones is prepared from the reaction of one or more 1,3-dienes with CO₂; wherein the one or more alcohols are of formulation (HO)y-R1-OH, where R1 is alkyl, alkenyl, or aryl, and y is from 1 to 25; wherein y equals 1; wherein step b) is conducted in the absence of alcohols and the polylactones formed in step b) are reacted with one or more alcohols to form one or more polyester polyol(s; wherein the alcohol or alcohols are chosen from among the group comprising: monoalcohols of formulation R—OH wherein R is alkyl, alkenyl, or aryl, diols, triols, or higher polyols, polyoxyalkylene polyols, alkylene polyols, 1,2-ethanediol (ethylene glycol), 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethylpropane-1,3-diol, 2-methyl-2,4-pentanediol, 2-ethyl-1,3-hexane dial, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, glycerol, glycerol monoesters, glycerol monoethers, trimethylolpropane monoesters, trimethylolpropane monoethers, pentaerythritol, pentaerythritol diesters, pentaerythritol diethers, and alkoxylated derivatives of any of these, or aromatic polyols such as hydroquinone, catechol (1,2-dihydroxybenzene), or resorcinol (1,3-dihydroxybenzene), or renewable polyols such as sugars; wherein the polyester polyol is of Structure (3) prepared from a lactone of Structure (2) wherein
a) R1 is from alkyl or aryl,
b) n is selected from 1-1,000,
c) x is from 2-10, and
d) z is from 0 to 20.

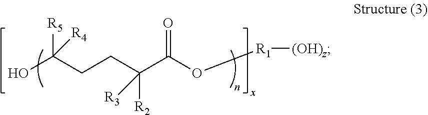

wherein z equals 0, 1, or 2 and R1 is an alkyl with from 2 to 10 carbon atoms; wherein step b) is conducted at −20 to 150, 0 to 120, or 20 to 80° C.; wherein the molar ratio of lactone monomer to hydroxyl groups (OH) on the alcohol or alcohols is at least 5, 10, 15, 20, 25, 30, 35, 40, or 50 to one, or from 5 to 100, 15 to 80, 20 to 50, or 25 to 35 to one, or no more than 20, 25, 30, 35, 40, 50, or 80 to one; wherein step b) is conducted in the presence of a base, and optionally, a catalyst and a solvent; wherein the process is conducted in the presence of a catalyst and wherein the catalyst is chosen from among a) nucleophilic catalysts optionally selected from 4-dimethylaminopyridine, phosphines, ureas, thioureas, or N-heterocyclic carbenes, b) tertiary amine compounds, triethylamine, triethylenediamine, N-methylmorpholine, N,N-dimethylcyclohexylamine, pentamethyldiethylenetriamine, tetramethylethylenediamine, 1-methyl-4-dimethylaminoethylpiperazine, 3-methoxy-Ndimethylpropylamine, N-ethylmorpholine, diethylethanolamine, N-cocomorpholine, N,N-dimethyl-N′,N′-dimethyl isopropylpropylenediamine, N,N-diethyl-3-di-ethyl aminopropyl amine dimethyl benzyl amine, 1,8-Diazabicycloundec-7-ene (DBU), 1,4-diazabicyclo[2.2.2]octane (DABCO) triazabicyclodecene (TBD), and N-methyltriazabicyclodecene (MTBD), or some combination thereof, or, c) organometallic catalysts, organomercury, organ lead, organoiron and organotin catalysts, stannous chloride, tin salts of carboxylic acids, dibutyltin dilaurate, dibutylbis(arylthio) stannate, dibutyltinbis(isooctylmercapto acetate), dibutyltinbis(isooctylmaleate), tin octanoate, alkyl tin carboxylates, organometallic compounds based on mercury, lead, bismuth (bismuth octanoate), or zinc, mercury carboxylates, phenylmercuric neodecanoate, dibutyltin dilaurate, dioctyl tin mercaptide, dibutyl tin oxide, tin mercaptides. alkali metal alkoxide, or d) mixtures of any of these;
wherein the catalyst is chosen from among nucleophilic catalysts such as 4-dimethylaminopyridine, phosphines, ureas, thioureas or N-heterocyclic carbenes; wherein the base is present in an amount ranging from at least 0.001, 0.01, 0.05, 0.1, 0.5, 1.0, 3.0, or 10.0 mol %, or from 0.001 to 10, 0.05 to 3.0, or 0.1 to 1.0 mol % based on the total moles of lactone; wherein the process is conducted in the presence of a polar aprotic solvent; conducted in the presence of a catalyst wherein the catalyst is present in an amount ranging from at least 0.01, 0.05, 0.1, 0.5, 1.0, 3.0, or 10.0 mol %, or from 0.01 to 10, 0.05 to 3.0, or 0.1 to 1.0 mol % based on the total moles of lactone; wherein the polyester polyol is recovered by diluting with a polar aprotic solvent, filtering or washing with solvent to remove catalyst, and removing the solvent and other light materials in vacuo; wherein the solvent is chosen from among dichloromethane, chloroform, tetrahydrofuran, methyl-tert-butyl ether, diethyl ether, toluene, benzene, dioxane, hexanes, and pentane; wherein the polyester polyol is filtered or washed, and distilled in vacuo at less than 25, 15, 10, 5, 1, 0.5, or 0.1 torr, or from 0.1 to 25, 0.5 to 15, or 0.5 to 5 torr, at a temperature of at least 50, 100, 125, 150, or 180° C., or from 50 to 300, or 100 to 250, or 150 to 200° C., to remove solvent and residual monomer and recover polyester polyol; wherein the recovered polyester polyol comprises less than 2, 1, 0.5, 0.1, or 0.05%, or from 0.001 to 2, or 0.01 to 1, or 0.05 to 0.5% by weight the sum of solvent and monomer as characterizable by 1H NMR; wherein at least one of R2, R3, R4, or R5 is an alkenyl moiety, and the pendent olefin is reacted with a multi-mercapto coupling agent to form a cross-linked polyester polyol; wherein at least one of R2, R3, R4, or R5 is an alkenyl moiety, at least one pendent olefin is modified with the thiol-ene click reaction to form a thioether; wherein at least one of R2, R3, R4, or R5 is an alkenyl moiety and at least one pendant olefin is reacted with another olefin via olefin metathesis; wherein at least one of R2, R3, R4, or R5 is an alkenyl moiety and the at least one pendant olefin is modified by reaction with a 1,3-diene in a Diels-Alder reaction; wherein the 1,3-diene is chosen from among 1,3-butadiene, isoprene, terpenes, 1,2-propadiene (allene), 1,3-hexadiene, myrcene, chloroprene, or any terminally unsaturated 1,3-diene of the formula CH2═CH—CR═CHR′ where R and R′ are independently H, or a saturated or unsaturated alkyl or aryl group, or a halogen radical, or some combination thereof; wherein the 1,3-diene is 1,3-butadiene and the lactone is 3-ethylidene-6-vinyltetrahydro-2H-pyran-2-one (EVP; wherein the 1,3-diene is 1,3-butadiene dissolved in the range of at least 10, 20, 30, 40, 50, 60, or 80, or from 5 to 90, 20 to 80, or 30 to 60% by weight 1,3-diene in an aprotic solvent; wherein the 1,3-diene is 1,3-butadiene dissolved in an aprotic solvent chosen from among toluene, tetrahydrofuran, diethyl carbonate, ethylene carbonate, propylene carbonate, and acetonitrile; wherein the process is conducted in the presence of a catalyst wherein the catalyst comprises a source of palladium and one or more phosphines or polyphosphines in a solvent; wherein the product is filtered or washed with solvent to remove catalyst and distilled at atmospheric pressure to remove the solvent; wherein the product is filtered or washed with a solvent and distilled in vacuo at pressure less than 10, 5, 1, 0.5, 0.1, or 0.05 torr, or from 0.1 to 15, or 0.5 to 5 torr at temperatures of not more than 50, 60, 70, 80, or 90° C., or from 20 to 120, 50 to 110, or 70 to 100° C., to produce a purified product; wherein the lactone is hydrogenated to form hydrogenated lactones; wherein the lactone is hydrogenated to form 3-ethyl-6-vinyltetrahydro-2H-pyran-2-one (EtVP), 3,6-diethyltetrahydro-2H-pyran-2-one (DEtP), or 3,6-divinyltetrahydro-2H-pyran-2-one (DVP), or some combination thereof; wherein the ratio of EtVP to the sum of DEtP and DVP is at least 2 to 1, 5 to 1, 10 to 1, 15 to 1, 20 to 1, 25 to 1, or 50 to 1, or from 2 to 1 to 100 to 1, 5 to 1 to 50 to 1, or 10 to 1 to 50 to 1 by mass; wherein the lactone is hydrogenated to form 3-ethyl-6-vinyltetrahydro-2H-pyran-2-one (EtVP); wherein the lactone is hydrogenated to form 3,6-diethyltetrahydro-2H-pyran-2-one (DEtP); wherein the hydrogenation is carried out in the presence of a solvent a) with a reducing agent chosen from among hydrogen, trichlorosilane, sodium borohydride, or b) electrochemically, to form a hydrogenated lactone; wherein the solvent is an aprotic polar solvent chosen from among tetrahydrofuran, toluene, dichloromethane, chloroform, diether, polyether, dimethyl sulfoxide, or dimethylformamide; wherein the hydrogenation is carried out at a temperature less than 20, 15, 10, 5, or 0° C., or from −20 to 15, −15 to 10, or −10 to 5° C., for a time of at least 1, 4, 8, 12, 16 or 20 hours, or from 1 to 48, 4 to 36, 8 to 24, or 12 to 20 hours, or less than 100, 72, 48, 36, 24, or 16 hours; wherein the hydrogenated lactone is filtered or washed with solvent to remove catalyst and distilled at atmospheric pressure to remove the solvent; wherein the hydrogenated lactone is filtered or washed with solvent and recovered by distillation of the filtered or washed product in vacuo at pressure less than 10, 5, 1, 0.5, 0.1, or 0.05 torr, or from 0.1 to 15, or 0.5 to 5 torr at temperatures of not more than 50, 60, 70, 80, or 90° C., or from 20 to 120, 50 to 110, or 70 to 100° C., to produce a purified product; wherein the lactone is isomerized to form 3,6-divinyltetrahydro-2H-pyran-2-one (DVP); wherein the 1,3-diene is bio-based butadiene; wherein the CO₂ is CO₂ recovered from ammonia production, fermentation, anaerobic digestion, cement manufacture, waste incineration flue gas, or direct air capture, or some combination thereof; wherein the method further includes crosslinking the polyester through a pendent olefin to yield a modified polyester; wherein crosslinking the polymer through a pendent olefin comprises reacting the pendent olefin with a multi-mercapto coupling agent or modifying the pendent olefin with a thiol-ene click reaction; wherein the polyester reaction with a multi-mercapto coupling agent or modifying the pendent olefin in a thiol-ene click reaction is conducted with a carboxylic acid or a tertiary amine; wherein a pendant olefin on the lactone is metathesized by reaction with another olefin before proceeding to step b); and/or wherein a pendant olefin on the polyester polyol from step c) is metathesized by reaction with another olefin.

In another aspect, the invention provides a process for producing polyurethanes comprising: providing one or more polyester polyols of Structure (3) wherein i) R1 is selected from alkyl or aryl, ii) n is selected from 1-1,000, iii)x is selected independently from 2-10, and
iv) z is selected from 0 to 20,

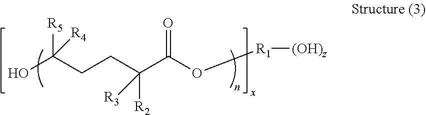

reacting the polyester polyol(s) with one or more polyisocyanates to form one or more polyurethanes, and recovering the polyurethanes.

In a further aspect, the invention provides a process for producing polyurethanes comprising: providing one or more lactones of Structure (2), wherein R2, R3, R4, and R5 are independently selected from H, alkyl, alkenyl, vinylidenyl, or aryl functional groups,

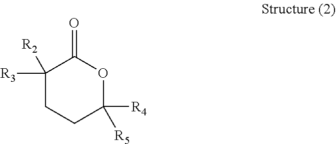

reacting the lactones with one or more polyols to form one or more polyester polyol(s), reacting the polyester polyol(s) with one or more polyisocyanates to form one or more polyurethanes, and recovering the polyurethanes.

The above aspects can be further characterized by one or any combination of the following: wherein one or more of the polyester polyols is prepared from a lactone prepared from the reaction of one or more 1,3-dienes with CO₂; wherein the polyurethane has a storage modulus response ranging from 100-1,000,000 Pa over the range from 0-200° C.; wherein the storage modulus of the polyurethane is from 100,000 to 5,000,000 at 60° C. and from 200 to 10,000 at 160° C.; wherein the storage modulus of the polyurethane at 80° C. is at least 50,000, 100,000, 500,000, 1,000,000, 2,500,000, or 4,000,000, or from 100,000 to 5,000,000, 150,000 to 4,000,000, or 250,000 to 3,000,000, and at 160° C. is at least 100, 200, 400, 500, 1,000, 2,500, 5,000, or less than 20,000, 10,000, 5,000, 2,500, 1,000, 500, or 200, or from 200 to 10,000, 200 to 5,000, or 500 to 2,500; wherein the polyisocyanate is chosen from among diethylbenzene diisocyanate, 2,4- or 2,6-tolylene diisocyanate, m-xylylene diisocyanate, 4,4′-diphenylmethane diisocyanate (MDI), p-phenylene diisocyanate, 1,5-naphthalene diisocyanate, dianisidine diisocyanate, tolidine diisocyanate, a,a,a′,a′-tetramethylxylylene diisocyanate, tetrahydronaphthalene-1,5 diisocyanate, and bis(4-isocyanatophenyl) methane, methylene diisocyanate, propylene diisocyanate: tetramethylene diisocyanate, pentamethylene diisocyanate, hexamethylene diisocyanate, decamethylene 1,10-diisocyanate, cyclohexylene 1,2-diisocyanate, lysine diisocyanate, 2,2,4- or 2,4,4-trimethyl hexamethylene diisocyanate, alicyclic diisocyanates such as 1,4-cyclohexane diisocyanate, methylcyclohexane diisocyanate (hydrogenated TDI), 1-isocyanato-3-isocyanatomethyl 1-3,5,5-trimethyl cyclohexane (IPDI), 4,4′-dicyclohexylmethane diisocyanate, isopropylidenedicyclohexyl-4,4′-diisocyanate, isophorone diisocyanate, or other aromatic polyisocyanates, aliphatic polyisocyanates, aromatic ring-containing aliphatic diisocyanates, and the like; wherein a catalyst used selected from among a) tertiary amine compounds, triethylamine, triethylenediamine, N-methylmorpholine, N,N-dimethylcyclohexylamine, pentamethyldiethylenetriamine, tetramethylethylenediamine, 1-methyl-4-dimethylaminoethylpiperazine, 3-methoxy-Ndimethylpropylamine, N-ethylmorpholine, diethylethanolamine, N-cocomorpholine, N,N-dimethyl-N′,N′-dimethyl isopropylpropylenediamine, N,N-diethyl-3-di-ethyl aminopropyl !amine dimethyl benzyl amine, 1,8-Diazabicycloundec-7-ene (DBU), 1,4-diazabicyclo[2.2.2]octane (DABCO) triazabicyclodecene (TBD), and N-methyltriazabicyclodecene (MTBD), or some combination thereof, or, b) organometallic catalysts, organomercury, organ lead, organoiron and organotin catalysts, stannous chloride, tin salts of carboxylic acids, dibutyltin dilaurate, dibutylbis(arylthio) stannate, dibutyltinbis(isooctylmercapto acetate), dibutyltinbis(isooctylmaleate), tin octanoate, alkyl tin carboxylates, organometallic compounds based on mercury, lead, bismuth (bismuth octanoate), or zinc, mercury carboxylates, phenylmercuric neodecanoate, dibutyltin dilaurate, dioctyl tin mercaptide, dibutyl tin oxide, tin mercaptides, alkali metal alkoxide, or mixtures of any of these; wherein the polyester polyol of Structure (3) comprises at least 50, 60, 70, 80, 90, or 99% by weight, or between 50 and 99.9% by weight of the total weight of the polyol present in the polyol component and the balance may comprise one or more polyols selected from the group consisting of polyether polyols, polyester polyols, polybutadiene polyols, polysulfide polyols, natural oil polyols, fluorinated polyols, aliphatic polyols, polycarbonate polyols, and mixtures of any two or more these; wherein the isocyanate comprises a crosslinker isocyanate with a functionality of at least 3; wherein a crosslinker is used in an amount which corresponds to an NCO:OH equivalents ratio of at least 1, 1.2, 1.5, 2.0, 2.3, 2.5, 3.0, or 4.0, or from 0.5 to 5.0, 0.75 to 4.0, 0.8 to 3.0, 1.0 to 2.5, or 1.2 to 2.3; wherein one or more of the lactones is prepared from the reaction of one or more 1,3-dienes with CO2; wherein the polyurethane has a storage modulus response ranging from 100-1,000,000 Pa over the range from 0-200° C.; wherein the storage modulus of the polyurethane is from 100,000 to 5,000,000 at 80° C. and from 200 to 10,000 at 160° C.; wherein the storage modulus of the polyurethane at 80° C. is at least 50,000, 100,000, 500,000, 1,000,000, 2,500,000, or 4,000,000, or from 100,000 to 5,000,000, 150,000 to 4,000,000, or 250,000 to 3,000,000, and at 160° C. is at least 100, 200, 400, 500, 1,000, 2,500, 5,000, or less than 20,000, 10,000, 5,000, 2,500, 1,000, 500, or 200, or from 200 to 10,000, 200 to 5,000, or 500 to 2,500; wherein the polyol or polyols are of formulation (HO)y-R1-OH, R1 is alkyl, alkenyl, or aryl, and y is from 1 to 25; wherein y equals 1; wherein the polyester polyol is of Structure (3) prepared from a lactone of Structure (2) wherein a) R1 is selected from alkyl or aryl, b) n is selected from 1-1,000, c) x is selected independently from 2-10, and d) z is selected from 0 to 20; wherein z equals 0, 1, or 2 and R1 is an alkyl with from 2 to 10 carbon atoms; wherein step b) is conducted at −20 to 150, 0 to 120, or 20 to 80° C.; wherein the ratio of lactone monomer to hydroxyl groups (OH) on the polyol is at least 3, 10, 15, 20, 25, 30, 35, 40, or 50 to one, or from 3 to 100, 15 to 80, 20 to 50, or 25 to 35 to one, or no more than 20, 25, 30, 35, 40, 50, or 80 to one; wherein step b) is conducted in the presence of a base and, optionally, a catalyst and a solvent; wherein the base is chosen from among anionic bases such as hydroxides, amides or alkoxides, or weak bases such as potassium bis(trimethylsilyl)amide or 1,5,7-triazabicyclo[4.4.0]dec-5-ene, or the like; wherein the catalyst is chosen from among a) nucleophilic catalysts such as 4-dimethylaminopyridine, phosphines, ureas, thioureas, or N-heterocyclic carbenes, b) tertiary amine compounds, triethylamine, triethylenediamine, N-methylmorpholine, N,N-dimethylcyclohexylamine, pentamethyldiethylenetriamine, tetramethylethylenediamine, 1-methyl-4-dimethylaminoethylpiperazine, 3-methoxy-Ndimethylpropylamine, N-ethylmorpholine, diethylethanolamine, N-cocomorpholine, N,N-dimethyl-N′,N′-dimethyl isopropylpropylenediamine, N,N-diethyl-3-di-ethylaminopropyl amine dimethyl benzylamine, 1,8-Diazabicycloundec-7-ene (DBU), 1,4-diazabicyclo[2.2.2]octane (DABCO) triazabicyclodecene (TBD), and N-methyltriazabicyclodecene (MTBD), or some combination thereof, or, c) organometallic catalysts, organomercury, organ lead, organoiron and organotin catalysts, stannous chloride, tin salts of carboxylic acids, dibutyltin dilaurate, dibutylbis(arylthio) stannate, dibutyltinbis(isooctylmercapto acetate), dibutyltinbis(isooctylmaleate), tin octanoate, alkyl tin carboxylates, organometallic compounds based on mercury, lead, bismuth (bismuth octanoate), or zinc, mercury carboxylates, phenylmercuric neodecanoate, dibutyltin dilaurate, dioctyl tin mercaptide, dibutyl tin oxide, tin mercaptides. alkali metal alkoxide, or d) mixtures of any of these; wherein the process is conducted in the presence of a polar aprotic solvent; wherein the polar aprotic solvent is chosen from among dichloromethane, chloroform, tetrahydrofuran, methyl-tert-butyl ether, diethyl ether, toluene, benzene, dioxane, hexanes, and pentane; wherein the base is present in an amount ranging from at least 0.001, 0.01, 0.05, 0.1, 0.5, 1.0, 3.0, or 10.0 mol %, or from 0.001 to 10, 0.05 to 3.0, or 0.1 to 1.0 mol % based on the total moles of lactone; wherein the catalyst is present in an amount ranging from at least 0.01, 0.05, 0.1, 0.5, 1.0, 3.0, or 10.0 mol %, or from 0.01 to 10, 0.05 to 3.0, or 0.1 to 1.0 mol % based on the total moles of lactone; wherein the polyester polyol produced in claim 60 or 61 is recovered by diluting with a polar aprotic solvent, filtered or washed with solvent to remove catalyst, and the solvent and other light materials are removed in vacuo; wherein the polyester polyol is filtered or washed and distilled in vacuo at less than 25, 15, 10, 5, 1, 0.5, or 0.1 torr, or from 0.1 to 25, 0.5 to 15, or 0.5 to 5 torr at temperatures of at least 50, 100, 125, 150, or 180° C., or from 50 to 300, or 100 to 250, or 150 to 200° C., to remove solvent and residual monomer and recover polyester polyol; wherein the polyester polyol comprises less than 2, 1, 0.5, 0.1, or 0.05%, or from 0.001 to 2, or 0.01 to 1, or 0.05 to 0.5% by weight the sum of solvent and monomer as characterizable by 1H NMR; wherein the polyisocyanate is chosen from among diethylbenzene diisocyanate, 2,4- or 2,6-tolylene diisocyanate, m-xylylene diisocyanate, 4,4′-diphenylmethane diisocyanate (MDI), p-phenylene diisocyanate, 1,5-naphthalene diisocyanate, dianisidine diisocyanate, tolidine diisocyanate, a,a,a′,a′-tetramethylxylylene diisocyanate, tetrahydronaphthalene-1,5 diisocyanate, and bis(4-isocyanatophenyl) methane, methylene diisocyanate, propylene diisocyanate: tetramethylene diisocyanate, pentamethylene diisocyanate, hexamethylene diisocyanate, decamethylene 1,10-diisocyanate, cyclohexylene 1,2-diisocyanate, lysine diisocyanate, 2,2,4- or 2,4,4-trimethyl hexamethylene diisocyanate, alicyclic diisocyanates such as 1,4-cyclohexane diisocyanate, methylcyclohexane diisocyanate (hydrogenated TDI), 1-isocyanato-3-isocyanatomethyl 1-3,5,5-trimethyl cyclohexane (IPDI), 4,4′-dicyclohexylmethane diisocyanate, isopropylidenedicyclohexyl-4,4′-diisocyanate, isophorone diisocyanate, or other aromatic polyisocyanates, aliphatic polyisocyanates, aromatic ring-containing aliphatic diisocyanates, and the like, or some combination thereof; wherein the molar ratio of polyisocyanate to polyester polyol is from 0.01 to 100, 0.1 to 20, 0.5 to 10, 0.8 to 5, or 0.95 to 1.5 to one, or at least 0.5, 0.8, 1, 2, 5, or 10 to one, or less than 10, 5, 2, 1, 0.8, or 0.5 to one; wherein the molar ratio of isocyanate (—NCO) moieties to hydroxyl (—OH) moieties in the mixture of materials used for polyurethane production is from 0.5 to 2, 0.7 to 1.5, 0.8 to 1.2, 0.9 to 1.1, or 0.95 to 1.05 to one, or at least 0.7, 0.8, 1, 1.1, 1.2, or 1.3 to one, or less than 2, 1.5, 1.2, 1.1, 0.95, or 0.9 to one.

In another aspect, the invention provides a polyester polyol of Structure (3),

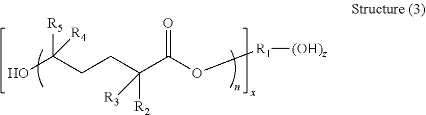

wherein R1 is selected from alkyl or aryl, wherein R2, R3, R4, and R5 are independently selected from H, alkyl, alkenyl, or aryl functional groups, and n is selected from 1-1,000, x is selected from 2-10, and z is selected from 0 to 20.

The polyester polyol can be further characterized by one or any combination of the following: wherein the carboxylate group was derived from CO2 in a reaction with a 1,3-diene; comprising less than 2, 1, 0.5, 0.1, or 0.05%, or from 0.001 to 2, or 0.01 to 1, or 0.05 to 0.5% by weight the sum of solvent and monomer as determined by 1H NMR; wherein z equals 0, 1, or 2 and R1 is an alkyl with from 2 to 10 carbon atoms; wherein at least one of R2, R3, R4, and R5 is an alkenyl moiety; wherein at least one of R2 and R3 is an alkenyl moiety, and at least one of R4, and R5 is an alkenyl moiety; where the alkenyl moiety or moieties are vinyl moieties.

The invention also includes a blended polymer mix comprising the polyester made by any of the inventive methods and one or more materials selected from polyether polyols, polyester polyols, polybutadiene polyols, polysulfide polyols, natural oil polyols, fluorinated polyols, aliphatic polyols, polycarbonate polyols, polyethylene, polypropylene, polybutadiene, polylactic acid, polystyrene, polyethylene terephthalic acid ester (PET), polyvinyl chloride (PVC), or acrylonitrile-butadiene-styrene copolymer (ABS), or some mixture of these.

The invention further provides a polyurethane comprising the products of reaction of

### a) One or More Polyester Polyols of Structure (3)

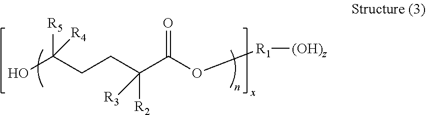

i) wherein R1 is selected from alkyl or aryl, ii) wherein R2, R3, R4, and R5 are independently selected from H, alkyl, alkenyl, or aryl functional groups, iii) n is selected from 1-1,000, x is selected from 2-10, and z is selected from 0 to 20, and b) one or more polyisocyanates; wherein the polyester polyol comprises one or more lactones prepared by the reaction of one or more 1,3-dienes and CO₂; wherein the molar ratio of polyisocyanate to polyester polyol is from 0.01 to 100, 0.1 to 20, 0.5 to 10, 0.8 to 5, or 0.95 to 1.5 to one, or at least 0.5, 0.8, 1, 2, 5, or 10 to one, or less than 10, 5, 2, 1, 0.8, or 0.5 to one; wherein the molar ratio of isocyanate (—NCO) moieties to hydroxyl (—OH) moieties in the mixture of materials used for polyurethane production is from 0.5 to 2, 0.7 to 1.5, 0.8 to 1.2, 0.9 to 1.1, or 0.95 to 1.05 to one, or at least 0.7, 0.8, 1, 1.1, 1.2, or 1.3 to one, or less than 2, 1.5, 1.2, 1.1, 0.95, or 0.9 to one; wherein the polyester polyol is prepared from a lactone selected from among 3-ethyl-6-vinyltetrahydro-2H-pyran-2-one (EtVP), 3,6-diethyltetrahydro-2H-pyran-2-one (DEtP), or 3,6-divinyltetrahydro-2H-pyran-2-one (DVP), or some combination thereof; wherein the one or more polyisocyanates are chosen from among: diethylbenzene diisocyanate, 2,4- or 2,6-tolylene diisocyanate, m-xylylene diisocyanate, 4,4′-diphenylmethane diisocyanate (MDI), p-phenylene diisocyanate, 1,5-naphthalene diisocyanate, dianisidine diisocyanate, tolidine diisocyanate, a,a,a′,a′-tetramethylxylylene diisocyanate, tetrahydronaphthalene-1,5 diisocyanate, and bis(4-isocyanatophenyl) methane, methylene diisocyanate, propylene diisocyanate: tetramethylene diisocyanate, pentamethylene diisocyanate, hexamethylene diisocyanate, decamethylene 1,10-diisocyanate, cyclohexylene 1,2-diisocyanate, lysine diisocyanate, 2,2,4- or 2,4,4-trimethyl hexamethylene diisocyanate, alicyclic diisocyanates such as 1,4-cyclohexane diisocyanate, methylcyclohexane diisocyanate (hydrogenated TDI), 1-isocyanato-3-isocyanatomethyl 1-3,5,5-trimethyl cyclohexane (IPDI), 4,4′-dicyclohexylmethane diisocyanate, isopropylidenedicyclohexyl-4,4′-diisocyanate, isophorone diisocyanate, or other aromatic polyisocyanates, aliphatic polyisocyanates, aromatic ring-containing aliphatic diisocyanates, and the like, or some combination thereof; wherein the isocyanate comprises a crosslinker with a functionality of at least 3; wherein the isocyanate comprises a crosslinker used in an amount which corresponds to an NCO:OH equivalents ratio of at least 1, 1.2, 1.5, 2.0, 2.3, 2.5, 3.0, or 4.0, or from 0.5 to 5.0, 0.75 to 4.0, 0.8 to 3.0, 1.0 to 2.5, or 1.2 to 2.3; wherein the polyurethane comprises one or more of chain-extenders, diols, hydrazine, catalysts, tertiary amines or tin compounds, surfactants, siloxane-oxyalkylene copolymers, blowing agents, water, trichlorofluoromethane, cross-linking agents, triethanolamine, fillers, pigments, fire retardants, foam stabilizers, antioxidants, and the like.

The invention also includes a blended polymer mix comprising the polyurethane and one or more materials selected from polyethylene, polypropylene, polyesters, polyethylene terephthalate (PET), acrylonitrile-butadiene-styrene (ABS) copolymers, polyamide, polyethers, polycarbonates, poly(oxides), poly(sulfides), polyarylates, polyetherketones, polyetherimides, polysulfones, polyvinyl alcohols, polymers produced by polymerization of monomers, such as, for example, dienes, olefins, styrenes, acrylates, acrylonitrile, methacrylates, methacrylonitrile, diacids and diols, lactones, diacids and diamines, lactams, vinyl esters, block copolymers thereof, and alloys thereof; thermoset polymers such as, for example, epoxy resins; phenolic resins; melamine resins; alkyd resins; vinyl ester resins; unsaturated polyester resins; crosslinked polyurethanes; polyisocyanurates; crosslinked elastomers, including but not limited to, polyisoprene, polybutadiene, styrene-butadiene, styrene-isoprene, ethylene-propylene-diene monomer polymer; or some combination thereof.

The blended polymer or polyurethane can be further characterized by one or any combination of the following: wherein the polyurethane comprises at least 10, 20, 30, 40, 50, 60, 70, 80, 90, 95, or 99% by weight of the blended polymer; wherein the polyurethane has a storage modulus that is at least 5, 10, 50, 100, 250, 300, or 500 times greater at 60° C. than at 160° C., or from 5 to 1000, 10 to 550, 50 to 250, or 75 to 200 times greater at 60° C. than at 160° C., or less than 10, 50, 100, 250, 300, 600, or 1000 times greater at 60° C. than at 160° C. as measurable by rheometry; wherein the polyurethane has a loss modulus that is at least 5, 10, 25, 40, 60, 80, or 90 times greater at 60° C. than at 160° C., or from 1 to 200, 5 to 120, 10 to 100, or 60 to 95 times greater at 60° C. than at 160° C., or less than 200, 120, 100, 75, 50, 25, or 15 times greater at 60° C. than at 160° C. wherein the polyurethane has a ratio of the loss modulus to the storage modulus at 60° C. of at least 0.02, 0.04, 0.10, 0.20, or 0.40, or from 0.02 to 0.75, or from 0.04 to 0.50, or less than 1.0, 0.8, 0.5, 0.25, or 0.10 wherein the polyurethane has a ratio of the loss modulus to the storage modulus at 160° C. of at least 0.10, 0.20, 0.30, 0.50, or 0.80, or from 0.10 to 1.0, 0.2 to 0.9, or 0.25 to 0.40, or less than 1.0, 0.9, 0.4, 0.30, or 0.25.

The invention also provides a process for preparing polyurethane foam comprising providing one or more polyester polyol of Structure (3) wherein i) R1 is selected from alkyl or aryl, ii) R2, R3, R4, and R5 are independently selected from H, alkyl, alkenyl, or aryl functional groups, and iii) n is selected from 1-1,000, x is selected from 2-10, and z is selected from 0 to 20, providing one or more polyisocyanates, optionally mixed with one or more of catalysts, blowing agents, flame retardants, surfactants, or solvents, combining and mixing the polyester polyol and polyisocyanates, i) optionally by passing them together through a spray nozzle, ii) optionally with one or more gases, and allowing the foam mixture to cure into the polyurethane foam composition.

The process may further include one or more materials selected from polyethylene, polypropylene, polyesters, polyethylene terephthalate (PET), acrylonitrile-butadiene-styrene (ABS) copolymers, polyamide, polyethers, polycarbonates, poly(oxides), poly(sulfides), polyarylates, polyetherketones, polyetherimides, polysulfones, polyvinyl alcohols, polymers produced by polymerization of monomers, such as, for example, dienes, olefins, styrenes, acrylates, acrylonitrile, methacrylates, methacrylonitrile, diacids and diols, lactones, diacids and diamines, lactams, vinyl esters, block copolymers thereof, and alloys thereof; thermoset polymers such as, for example, epoxy resins; phenolic resins; melamine resins; alkyd resins; vinyl ester resins; unsaturated polyester resins; crosslinked polyurethanes; polyisocyanurates; crosslinked elastomers, including but not limited to, polyisoprene, polybutadiene, styrene-butadiene, styrene-isoprene, ethylene-propylene-diene monomer polymer; or some combination thereof is introduced with the polyisocyanate into the mixture of step c).

The process may be further characterized by one or any combination of the following: wherein the polyisocyanate comprises at least 10, 20, 30, 40, 50, 60, 70, 80, 90, 95, or 99% by weight of the polyisocyanate mixture of step c); wherein the polyester polyol is prepared from at least one lactone prepared from a 1,3-diene and CO₂; wherein the polyester polyol is prepared from a lactone prepared from butadiene and CO₂; wherein at least one of R2, R3, R4, and R5 is an alkenyl moiety; wherein at least one of R2 and R3 is an alkenyl moiety, and at least one of R4, and R5 is an alkenyl moiety; wherein the alkenyl moiety or moieties are vinyl moieties; wherein the polyester polyol is prepared from 3-ethyl-6-vinyltetrahydro-2H-pyran-2-one (EtVP), 3,6-diethyltetrahydro-2H-pyran-2-one (DEtP), or 3,6-divinyltetrahydro-2H-pyran-2-one (DVP), or any combination thereof.

The invention also provides a foam made by any of the inventive processes wherein the foam comprises one or more of chain-extenders, diols, hydrazine, catalysts, tertiary amines or tin compounds, surfactants, siloxane-oxyalkylene copolymers, blowing agents, water, trichlorofluoromethane, cross-linking agents, triethanolamine, fillers, pigments, fire retardants, foam stabilizers, antioxidants, and the like.

The invention also provides coatings, sealants, binder in an ink jet ink, foams (including rigid and flexible), polyisocyanurate foams, elastomers, dispersions, and other water dispersible applications, pipes, insulation, adhesives, surfactants, thermoplastic elastomers, rigid foams, insulating panels, refrigerators or coolers, flexible foams, mattresses, sofas, armchairs, shoes, synthetic leather, car seats, dash boards, sound insulation, or shock protection, or other automobile components, polishing pads used in chemical-mechanical polishing (CMP) processes, and the like. The polishing pads may further comprise high thermal conductivity materials chosen from among diamond particles, carbon nanotube particles, or highly thermally conductive metal particles such as Ag, Cu, or Au, or some combination thereof.

### BRIEF DESCRIPTION OF THE FIGURES

FIG. 1. Schematic process for producing polyurethane(s) that incorporates CO₂ and diene(s).

FIG. 2. Derivatives of EVP. The squiggly lines are meant to show that there are isomers available depending on the orientation at the ring carbon atom. Et=ethyl, E=ethylidenyl, V=vinyl, D=di, P=pyran-2-one.

### GLOSSARY

The term “aliphatic” or “aliphatic group”, as used herein, denotes a hydrocarbon moiety that may be straight chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-40 carbon atoms. In certain embodiments, aliphatic groups contain 1-20 carbon atoms. In certain embodiments, aliphatic groups contain 3-20 carbon atoms. In certain embodiments, aliphatic groups contain 1-12 carbon atoms. In certain embodiments, aliphatic groups contain 1-8 carbon atoms. In certain embodiments, aliphatic groups contain 1-6 carbon atoms. In some embodiments, aliphatic groups contain 1-5 carbon atoms, in some embodiments, aliphatic groups contain 1-4 carbon atoms, in some embodiments aliphatic groups contain 1-3 carbon atoms, and in some embodiments aliphatic groups contain 1 or 2 carbon atoms. Suitable aliphatic groups include, but are not limited to, linear or branched, alkyl, alkenyl, and alkynyl groups, and hybrids thereof such as (cycloalkyl) alkyl, (cycloalkenyl) alkyl or (cycloalkyl) alkenyl.

The term “alkyl,” as used herein, refers to saturated, straight- or branched-chain hydrocarbon radicals derived from an aliphatic moiety containing between one and six carbon atoms by removal of a single hydrogen atom. Unless otherwise specified, alkyl groups contain 1-12 carbon atoms. In certain embodiments, alkyl groups contain 1-8 carbon atoms. In certain embodiments, alkyl groups contain 1-6 carbon atoms. In some embodiments, alkyl groups contain 1-5 carbon atoms, in some embodiments, alkyl groups contain 1-4 carbon atoms, in some embodiments alkyl groups contain 1-3 carbon atoms, and in some embodiments alkyl groups contain 1-2 carbon atoms. Examples of alkyl radicals include, but are not limited to, methyl, ethyl, n-propyl, isopropyl, n-butyl, iso-butyl, sec-butyl, sec-pentyl, iso-pentyl, tert-butyl, n-pentyl, neopentyl, n-hexyl, sec-hexyl, n-heptyl, n-octyl, n-decyl, n-undecyl, dodecyl, and the like.

The term “alkenyl,” as used herein, denotes a monovalent group derived from a straight- or branched chain aliphatic moiety having at least one carbon-carbon double bond by the removal of hydrogen atoms. Typically, alkenyl groups contain 2 to 12, 2 to 8, 2 to 6, 2 to 5, 2 to 4, 2 to 3, or 2 carbon atoms. Alkenyl groups include, for example, ethenyl, propenyl, butenyl, 1,3-butadienyl, 1-methyl-2-buten-1-yl, and the like.

“Vinylidenyl,” as used herein refers to a moeity that is a substituted vinylidene such as in Structure (1) having a carbon-carbon double bond to another structure and R6 and R7 are selected from among H, alkyl, alkenyl, or aryl substituents on the vinyl carbon atom.

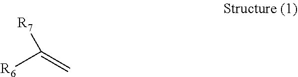

“Aryl” refers to substituted or unsubstituted aromatic hydrocarbons with a conjugated cyclic molecular ring structure of 3, 4, 5, 6, 7, 8, 9, 10, 11, or 12 carbon atoms. Typically, aryl groups contain 3 to 12 carbon atoms. Optionally, aryl includes one or more monocyclic, bicyclic or polycyclic rings. Optionally, aryl includes 1, 2, or 3 additional ring structures selected from the group consisting of a cycloalkyl, a cycloalkenyl, a heterocycloalkyl, a heterocycloalkenyl, or a heteroaryl. Optionally, aryl includes phenyl (benzenyl), thiophenyl, indolyl, naphthyl, totyl, xylyl, anthracenyl, phenanthryl, azulenyl, biphenyl, naphthalenyl, 1-methylnaphthalenyl, acenaphthenyl, acenaphthylenyl, anthracenyl, fluorenyl, phenalenyl, phenanthrenyl, benzo[a]anthracenyl, benzo[c]phenanthrenyl, chrysenyl, fluoranthenyl, pyrenyl, tetracenyl (naphthacenyl), triphenylenyl, anthanthrenyl, benzopyranyl, benzo[a]pyrenyl, benzo[e]fluoranthenyl, benzo[ghi]perylenyl, benzo[j]fluoranthenyl, benzo[k]fluoranthenyl, corannulenyl, coronenyl, dicoronylenyl, helicenyl, heptacenyl, hexacenyl, ovalenyl, pentacenyl, picenyl, perylenyl, and tetraphenylenyl. Optionally, aryl refers to aryls substituted with 1, 2, 3, 4, or 5 substituents selected from the group consisting of H, alkyl, aryl, alkenyl, alkynyl, arylalkyl, alkoxy, aryloxy, arylalkoxy, alkoxyalkylaryl, alkylamino, arylamino, 2-OMe-Ph, NH2, OH, CN, NO2, OCF3, CF3, Br, Cl, F, 1-amidino, 2-amidino, alkylcarbonyl, morpholino, piperidinyl, dioxanyl, pyranyl, heteroaryl, furanyl, thiophenyl, tetrazolo, thiazole, isothiazolo, imidazolo, thiadiazole, thiadiazole S-oxide, thiadiazole S,S-dioxide, pyrazolo, oxazole, isoxazole, pyridinyl, pyrimidinyl, quinoline, isoquinoline, SR′″, SOR′″, SO2R′″, CO₂R′″, COR′″, CONR′″R′″, CSNR′″R′″ and SOnNR′″R′″, wherein R′″ is alkyl or substituted alkyl. The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members.

“Bio-based” refers materials that have been produced from living or recently living animal or plant materials that can be determined by carbon-14 identification, the process of using the radioactive isotope carbon-14 to determine the percentage of a material that is derived from living or recently living organisms (bio-derived), as opposed to fossil fuels, by measuring the amount of carbon-14 present in a sample; since fossil fuels are very old and contain almost no carbon-14, this method effectively distinguishes between bio-based and petroleum-derived materials.

The criterion as bio-based is that the material should be recently participating in the carbon cycle so that the release of carbon in the combustion process results in no net increase averaged over a reasonably short period of time (for this reason, fossil fuels such as peat, lignite and coal are not considered biomass by this definition as they contain carbon that has not participated in the carbon cycle for a long time so that their combustion results in a net increase in atmospheric carbon dioxide).

“Cyclic Alkyl” refers to substituted or unsubstituted cyclic hydrocarbons having 3, 4, 5, 6, 7, 8, 9, 10, 11, 12, 13, 14, 15, 16, 17, 18, 19, or 20 carbon atoms linked exclusively by single bonds. Optionally, cyclic alkyl includes cyclopropane, cyclobutane, cyclopentane, cyclohexane, cycloheptane, or cyclooctane.

“Linear Alkyl” refers to substituted or unsubstituted straight-chain or branched-chain hydrocarbons having 1, 2, 3, 4, 5, 6, 7, 8, 9, 10, 11, 12, 13, 14, 15, 16, 17, 18, 19, or 20 carbon atoms linked exclusively by single bonds and not having any cyclic structure. Optionally, linear alkyl includes methyl, ethyl, n-propyl, isopropyl, n-butyl, isobutyl, sec-butyl, tert-butyl, pentyl, iso-amyl, hexyl, heptyl, octyl, nonyl, decyl, undecyl, dodecyl tridecyl, tetradecyl, pentadecyl, hexadecyl, heptadecyl, octadecyl, nonadecyl, and eicosyl.

A “Catalyst” is a substance that speeds up a chemical reaction, or lowers the temperature or pressure needed to initiate reaction, without itself being consumed during the reaction. Catalysts can also direct a reaction to increase the fraction of a specific product and reduce the fraction of other products; this is called selectivity.

A “moiety” is a specific group of atoms within a molecule that influences characteristic chemical reactions or properties of that molecule.

As used herein, the term “partially unsaturated” refers to a ring moiety that includes at least one double or triple bond. The term “partially unsaturated” is intended to encompass rings having multiple sites of unsaturation but is not intended to include aryl or heteroaryl moieties, as herein defined.

As described herein, compounds of the invention may contain “optionally substituted” moieties. In general, the term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position.

When substituents are described herein, the term “radical” or “optionally substituted radical” is sometimes used. In this context, “radical” means a moiety or functional group having an available position for attachment to the structure on which the substituent is bound. In general, the point of attachment would bear a hydrogen atom if the substituent were an independent neutral molecule rather than a substituent. The terms “radical” or “optionally-substituted radical” in this context are thus interchangeable with “group” or “optionally-substituted group”.

The term “polymer”, as used herein, refers to a molecule of high relative molecular mass, the structure of which comprises the multiple repetition of units derived, actually or conceptually, from molecules of low relative molar mass.

Relative molecular mass. In certain embodiments, a polymer is comprised of substantially alternating units derived from CO₂ and a 1,3-diene. In certain embodiments, a polymer of the present invention is a copolymer, terpolymer, heteropolymer, block copolymer, or tapered heteropolymer incorporating two or more different diene monomers. With respect to the structural depiction of such higher polymers, the convention of showing enchainment of different monomer units separated by a slash may be used herein These structures are to be interpreted to encompass copolymers incorporating any ratio of the different monomer units depicted unless otherwise specified. This depiction is also meant to represent random, tapered, block copolymers, and combinations of any two or more of these and all of these are implied unless otherwise specified.

“Branched” A branched chain polymer is a polymer with side chains, or branches, that are attached to a long chain of monomers. The branches can be of different lengths and can originate at random points along the chain. The branches may be made through the functionality of the monomer or through the substituent groups attached to the monomer such as alkenyl groups. “Highly branched” for the purposes of the present invention means that the degree of branching (DB) is 10% to 99.9%, preferably 20% to 99%, and more particularly from 20% to 95%. Degree of branching is a structural property that is determined by the concentration of linear (L), terminal (T) and dendritic (D) units within the polymer matrix. The degree of branching is the average number of dendritic links plus the average number of end groups per molecule, divided by the sum of average number of dendritic links, average number of linear links, and average number of end groups, i.e. sum total of monomers in the polymer, multiplied by 100. By “dendritic” in this context is meant that the degree of branching at this point in the molecule is 99.9 to 100%. For the definition of the degree of branching, refer also to H. Frey et al., Acta Polym. 1997, 48, 30.

“Crosslinked” polymers are polymers in which long polymer chains are linked together to form a 3D matrix of interconnected polymer chains. The degree of crosslinking that occurs is determined by the percentage of polymer chains that are interconnected in this network. Higher crosslink density is the result of more linkages per length of polymer chain, resulting in larger property changes. Because crosslinking prevents molecules from slipping by each other in the amorphous regions of the resin, it especially affects temperature-dependent properties, including: higher long-term service temperatures; better heat and dimensional stability; improved impact resistance and environmental stress-cracking resistance (ESCR); higher tensile strength and stiffness properties, especially at high temperatures; better “shape memory” or “memory effect,” in which a heated and deformed material holds its shape when cooled, and then returns to its original shape when reheated; improved cell formation in foams (stronger cell walls limit the cell-size distribution and prevent cells from blowing open); improved solvent resistance; better electrical resistance and dielectric properties; and in some cases, improved weatherability.

As used herein, the term “isomers” includes any and all geometric isomers and stereoisomers. For example, “isomers” include cis- and trans-isomers, E- and Z-isomers, R- and S-enantiomers, diastereomers, (D)-isomers, (L)-isomers, racemic mixtures thereof, and other mixtures thereof, as falling within the scope of the invention. For instance, a stereoisomer may, in some embodiments, be provided substantially free of one or more corresponding stereoisomers, and may also be referred to as “stereochemically enriched.” The invention additionally encompasses the compounds as individual isomers substantially free of other isomers and alternatively, as mixtures of various isomers, e.g., racemic mixtures of enantiomers. In addition to the above-mentioned compounds per se, this invention also encompasses compositions comprising one or more compounds.

The “number average molecular weight” (Mn) is the total weight of the sample divided by the number of molecules in the sample. The “weight average molecular weight” (Mw) refers to the average molecular weight of a mixture where larger molecules contribute more to the average due to their greater mass, essentially meaning the average is weighted based on the mass of each molecule rather than just the number of molecules present. Mn, the number average molecular weight, is calculated from the mole fraction distribution of different sized molecules in a sample, and Mw, the weight average molecular weight, is calculated from the weight fraction distribution of different sized molecules. The molecular weight distribution (MWD) of a polymer is based on the ratio of its weight average molecular weight (Mw) to its number average molecular weight (Mn). This ratio is called the Polydispersity Index (PDI) or Dispersity (D). The PDI is always one or greater because the weight average molecular weight is always equal to or greater than the number average molecular weight. “Polyisocyanate”. Polyisocyanates are compounds that contain more than one isocyanate moiety, —NCO, where the nitrogen atom is attached to the body of the molecule, R, and the oxygen is the terminus of the isocyanate moiety. The polyisocyanates used in the present invention may be represented by R(NCO)n wherein n is greater than 1, preferably 2-4, and R is an aliphatic, alicyclic, aliphatic-alicyclic, aromatic, or aliphatic-aromatic hydrocarbon compound of from 4 to 26 carbon atoms, but more conventionally from 6 to 20 and generally from 6 to 13 carbon atoms. Representative examples of the above isocyanates are: tetramethylene diisocyanate; hexamethylene diisocyanate; trimethylhexamethylene diisocyanate; dimer acid diisocyanate; isophorone diisocyanate; diethylbenzene diisocyanate; decamethylene 1,10-diisocyanate; cyclohexylene 1,2-diisocyanate and cyclochain hexylene 1,4-diisocyanate; and the aromatic isocyanates such as 2,4- and 2,6-tolylene diisocyanate; 4,4-diphenylmethane diisocyanate; 1,5-naphthalene diisocyanate; dianisidine diisocyanate; tolidine diisocyanate; a polymeric polyisocyanate such as neopentyl tetra isocyanate; m-xylylene diisocyanate; tetrahydronaphthalene-1,5 diisocyanate; and bis(4-isocyanatophenyl) methane. Descriptions of isocyanate compounds and analogs can be found in: “Chemistry and Technology of Polyols for Polyurethanes,” Ionescu, M., 2005, and Ulrich, H., “Polyurethanes,” Kirk-Othmer Encyclopedia of Chemical Technology, 1997 the entirety of each of which is incorporated herein by reference.

A “Polyol” is any molecule that has more than one hydroxyl group (—OH) appended to it. Examples include diols such as ethylene glycol, 1,3 propane diol, or the like, triols such as glycerol, 1,3,5-trihydroxypentane, 1,3,5-trihydroxybenzene, 2-deoxyribose, or the like, and materials with 4 or more hydroxyl groups.

“Polyurethane Flexible Foam” As defined herein, the term polyurethane foam means polyester based polyurethane foam or a combination polyether and polyester polyurethane foam. As noted, polyurethane foam is commonly produced by methods of molding and free-rise.

“Polyurethane foams” are often prepared at the point of use, sometimes by spraying the components together into a volume to be filled; these are called spray polyurethane foams (SPF). To create an SPF insulation or sealant, a chemical reaction occurs between two components, commonly referred to as “side A” and “side B” components. “Side A” is the mixture of materials that includes the polyisocyanates that are to be included in the polyurethane, and optionally solvents. “Side B” is a blend of polyols and any optional catalysts, blowing agents, flame retardants, surfactants or solvents that are to be used to prepare the polyurethane. To make polyurethane, the Side A and Side B materials are mixed in the correct ratio using a proportioning pump or other mixing device. Chemicals in SPF products leave the gun, nozzle, or straw and form a foam as the chemicals react. This chemical reaction is exothermic and generates heat.

“Adhesive” is any non-metallic substance applied to one or both surfaces of two separate items that binds them together and resists their separation. An adhesive can be either reactive or non-reactive, which refers to whether the adhesive chemically reacts in order to harden.

A “coating” is a covering that is applied to the surface of an object, or substrate as either liquid, gas, or solid (powder). Polyurethane coatings are defined as products made from polyisocyanates and polyols, and can be applied using water-borne, solvent-borne, high-solid, or powder coating systems.

“Elastomers” are polymers with viscoelasticity (meaning both viscosity and elasticity), generally amorphous polymers with cross-linked network structure that deform with low stress, and when the stress is removed, return to their original shape. Elastomeric polyurethanes are highly elastic, have great abrasion resistance, tear strength, chemical resistance, and wide temperature compatibility, and are often applied as coatings.

“Sealant” is a substance used to block the passage of fluids through openings in materials or for blocking dust, sound, and heat transmission. Sealants may be weak or strong, flexible or rigid, permanent or temporary. “Sealing foam” refers to expanding foams that polymerize immediately upon injection after leaving a holding vessel. They have very low fiber and solid particles content and have low viscosity, and are commonly used for emergency car tire or bicycle tire repairs.

### DETAILED DESCRIPTION OF THE INVENTION

The present invention provides a process for preparing polyester polyols in part from CO₂ comprises: telomerization of CO₂ with a diene to form one or more delta lactones, and polymerization one or more of the lactones with one or more diols or polyols. The present invention also provides a process for preparing polyester polyols in part from CO₂ comprises: telomerization of CO₂ with a diene to form one or more delta lactones, selective hydrogenation of the olefinic moiety conjugated with the carbonyl group of the lactone, and polymerization one or more of the lactones with one or more diols or polyols. The present invention further provides a process for preparing polyester polyols in part from CO₂ comprises: telomerization of CO₂ with a diene to form one or more delta lactones, hydrogenation of the carbon-carbon double bonds of the lactone, and polymerization one or more of the lactones with one or more diols or polyols. The present invention also provides a process for preparing polyester polyols in part from CO₂ comprises: telomerization of CO₂ with a diene to form one or more delta lactones, isomerization of the olefinic moiety conjugated with the carbonyl group of the lactone to a vinyl substituent, and polymerization of one or more of the lactones with one or more diols or polyols. The present invention further provides polyurethane compositions made from polyester polyols by methods provided herein.

The present invention provides a process for preparing polyurethanes derived in part from CO₂ comprising: 1) the telomerization of CO₂ with a diene to form a delta lactone, 2) either a) selective hydrogenation of the olefinic moiety conjugated with the carbonyl group of the lactone, or b) hydrogenation of both olefinic moeities, or c) isomerization of the olefinic moiety conjugated with the carbonyl group of the lactone to form a divinyl lactone, 3) polymerization of the lactone product of 2) with one or more diols or polyols, and 4) polymerization of the resulting polyester polyol with one or more polyisocyanates.

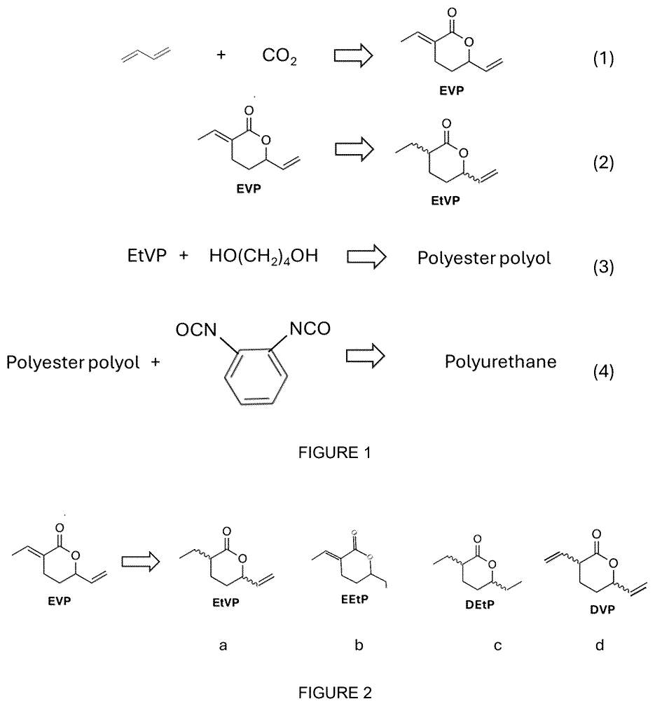

The overall sequence is shown in FIG. 1 for 1,3-butadiene as the diene, selective hydrogenation, 1,4-butanediol as the polyol, and 1,2-diisocyanatobenzene as the polyisocyanate.

The present invention provides methods for producing a polyurethane composition, the methods comprising the steps of:
a) providing one or more lactones derived from the telomerization of one or more dienes and CO₂;
b) polymerizing the lactones of a) with one or more polyols to form one or more polyester polyol(s). One or both of the vinyl moeities of the lactone or lactones of a) may be selectively hydrogenated or isomerized for use in b).

The present invention provides methods for producing a polyurethane composition, the methods comprising the steps of:
a) providing one or more lactones derived from the telomerization of one or more dienes and CO₂;
b) polymerizing the lactones of a) with one or more polyols to form one or more polyester polyol(s);
c) providing one or more polyisocyanates;
d) mixing polyester polyols of b) with polyisocyanates of c);
e) optionally heating the mixture to an elevated temperature; and
f) allowing the mixture to cure into the polyurethane composition;
   The lactone or lactones of a) may be selectively hydrogenated or isomerized for use in b). The process may include the catalytic telomerization of CO₂ with one or more 1,3-dienes to produce delta lactones as the initial step. The telomerization can be catalyzed by a source of zero-valent Pd and one or more phosphine ligands.

The present invention provides a process for producing a polyester polyol from a lactone prepared from CO₂ and one or more 1,3-dienes and one or more polyols.

The present invention provides polyurethane compositions prepared from CO₂, one or more 1,3-dienes, one or more polyols, and one or more polyisocyanates.

The present invention provides a process for disassembling polyurethanes incorporating CO₂, one or more 1,3-dienes, one or more polyols, and one or more polyisocyanates into constituent parts and recovering lactone derived from CO₂ and 1,3-diene therefrom. The present invention provides a process for disassembling polyester polyols incorporating CO₂, one or more 1,3-dienes, and one or more polyols, into constituent parts and recovering lactone derived from CO₂ and 1,3-diene therefrom.

A polyester polyol can be prepared from a lactone in a reaction with one or more polyols wherein the lactone was recovered from disassembling a polyurethane. Polyurethane can be prepared from polyester polyol prepared from the lactone recovered from disassembling a polyurethane or a polyester polyol. The present invention provides products produced from polyurethane compositions incorporating CO₂, one or more 1,3-dienes, one or more polyols, and one or more polyisocyanates. A molded polyurethane product can be produced by mixing the polyisocyanate component and the polyol component and then molding the mixture in a temperature-controlled foaming machine. The polyurethane product can be a pad for a Chemical Mechanical Polishing apparatus (CMP) used to polish a surface of a substrate for semiconductor production. The polyurethane can be formed into flexible or rigid polymeric foams, polyisocyanurate foams, coatings, sealants, adhesives, surfactants, and thermoplastic elastomers, insulating panels such as refrigerators or coolers, flexible foams such as mattresses, sofas, armchairs, car seats, shoes, synthetic leather, sound insulation, or shock protection.

### Process Overview

### Production of the Delta Lactone, e.g., EVP

The delta-lactone EVP (3-ethylidene-6-vinyltetrahydro-2H-pyran-2-one) and related structures can be produced from CO₂ and a 1,3-diene. The telomerization of CO₂ and the 1,3-diene has become well known in the art and typically employs a tertiary mono-phosphine and a Pd(0) precursor to produce EVP with good selectivity. While 1,3-butadiene and other 1,3-dienes are often produced as by-products of steam cracking, they can also be obtained from renewable feedstocks such as by pyrolyzing wood or other biomass.

In some embodiments the 1,3-diene used in the reaction can be any conjugated diene such as, but not limited to, 1,3-butadiene, isoprene, terpenes, 1,2-propadiene (allene), 1,3-hexadiene, myrcene, chloroprene, or any terminally unsaturated 1,3-diene of the formula CH2═CH—CR═CHR′ where R and R′ are independently H, or a saturated or unsaturated alkyl or aryl group, or a halogen radical. Preferably, the diene is butadiene or isoprene, and most preferably the diene is sourced from biomass resources.

Carbon dioxide can be obtained as the by-product of fermentation, anaerobic digestion, cement production, ammonia production, combustion flue gases, directly from the air, or any other source.

The first step of the process is the reaction of CO₂ with a 1,3-diene in an organic solvent using a catalyst. The solvent can be chosen from among aliphatic, aromatic, or halogenated hydrocarbons, ethers, esters, ketones, lactones, sulfones, nitriles, amides, nitromethane, propylene carbonate, dimethyl carbonate and the like. Representative examples include, but are not limited to: acetone, acetonitrile, benzene, butanol butyl acetate, g-butyrolactone, chloroform, cyclohexane, 1,2-dichloromethane, dibasic ester, diglyme, 1,2-dimethoxyethane, dimethylacetamide, dimethylsulfoxide, dimethyformamide, 1,4-dioxane, ethanol, ethyl acetate, ethyl ether, ethylene glycol, hexane, hydroxylmethyl methacrylate, isopropyl acetate, methanol, methyl acetate, methyl amyl ketone, methyl isobutyl ketone, methylene chloride, methyl ethyl ketone, monoglyme, methyl methacrylate, propylene carbonate, propylene oxide, styrene, alpha-terpineol, tetrahydrofuran, toluene, diethyl succinate, diethylene glycol methyl ether, ethylene glycol diacetate, triethyl phosphate or the like.

The catalyst for the reaction is typically a source of Pd(0) where palladium is present in the zero oxidation state or in the +2 oxidation state and one or more phosphine ligands. The source of Pd(0) can be any of a number of to organopalladium compounds, such as, but not limited to, PdCl2(MeCN)2, Pd(acac)2, Pd(dba)2 (dba=dibenzylideneacetone), or Pd2(dba)3, Pd(OAc)2, or the like. Alternatively, sources of Pd(0) include Pd(II) complexes that can be reduced in situ to produce Pd(0) species. Phosphine ligands of the formula PR3 are useful for the reaction, preferably sterically hindered phosphines such as P(Cy)3, P(2-OMe-Ph)3, PPh3, or P(2-furyl)3, where Cy=C6H11, Ph=C6H5, Me=CH3, 2-furyl=c-C4H3O, and R is an aryl or alkyl group, but not limited to these. Heterogeneous solid or supported catalysts containing palladium are also used for the telomerization reaction.

The 1,3-diene, solvent, Pd(0) precursor, and phosphine are charged to a pressure vessel that is pressurized with CO₂, heated to reaction temperature, and held at temperature while the reaction occurs. The pressure of CO2 in the vessel can be at least 3, 5, 10, 15, 20, 25, 30, or 35 bara, or from 3 to 50, 5 to 45, 15 to 40, 20 to 40, or 25 to 35 bara, or less than 200, 150, 100, 75, 50, or 40 bara. The temperature of the vessel can be raised to at least 30, 50, 60, 70, 80, or 100° C., or from 30 to 100, 40 to 95, 50 to 90, or 70 to 85° C., or less than 200, 150, 120, 100, or 90° C. during the reaction. The vessel can be kept at temperature for at least 1, 4, 8, 12, 16 or 20 hours, or from 1 to 48, 4 to 36, 8 to 24, or 12 to 20 hours, or less than 100, 72, 48, 36, 24, or 16 hours. The solution is filtered to remove the catalyst and distilled at atmospheric pressure to remove the solvent, leaving a crude EVP, which is distilled in vacuo to produce a purified EVP.

More generally, the reaction between a 1,3-diene and CO₂ can produce lactones of Structure (2)

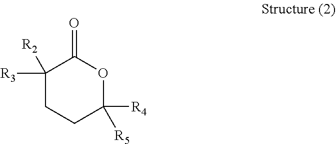

wherein R2, R3, R4, and R5 are independently selected from H, alkyl, alkenyl, vinylidenyl, or aryl functional groups.

### EVP Reduction to EtVP

EVP can be hydrogenated to produce EtVP (3-ethyl-6-vinyltetrahydro-2H-pyran-2-one), 3,6-diethyltetrahydro-2H-pyran-2-one (DEtP), or 3-ethylidene-6-ethyltetrahydro-2H-pyran-2-one (EEtP), or a mixture thereof.

EVP may be hydrogenated to yield selectively EtVP using trichlorosilane (Cl₃SiH) and a Lewis base, or other mild hydrogenating agent such as sodium borohydride. The Lewis base can be triphenylphosphine oxide, hexamethylphosphoramide (HMPA), or any of a variety of phosphine oxides, amines or the like, but not limited to these. Other reducing agents useful for converting EVP to EtVP include phosphine complexes of zero valent Group 8 metals (Ru, Rh, Pd, Os, Ir, Pt, Fe, Co, Ni). The reaction is carried out in a polar non-protic solvent such as dichloromethane at a temperature, typically less than 100, 70, 45, 20, 0, or −20° C., or from −20 to 100, 0 to 70, or 20 to 45° C., for a time of at least 1, 4, 8, 12, 16 or 20 hours, or from 1 to 48, 4 to 36, 8 to 24, or 12 to 20 hours, or less than 100, 72, 48, 36, 24, or 16 hours. Crude EtVP is isolated from the reaction mixture and distilled in vacuo to produce purified EtVP. EVP can be hydrogenated to DEtP by the use of somewhat harsher conditions of hydrogen pressure, temperature, and time of reaction, and the catalyst can be a less selective catalyst such as a supported Pd catalyst. Alternatively, EVP can be hydrogenated to EEtP by treatment with H2 in the presence of B(C6F5) in diethylether at 70° C. as disclosed in U.S. Pat. No. 11,312,677 EVP may be isomerized to DVP by exposure to a hindered radical initiator, sterically hindered metal complex such as Cyclopentadienyl ruthenium(II) compounds, or by radiation.

### Polyester Polyol Formation

Control of the number average molecular weight of the polyester polyol is important for controlling the balance of properties of the polyester polyol and the polyurethanes made from them. A polyester polyol having a high number average molecular weight and a narrow molecular weight distribution can be obtained with high yield which improves efficiency. When the number average molecular weight of the polyester polyol is not too high, the polyester polyol is sufficiently soluble in a solvent to facilitate ease of handling. When the number average molecular weight is 500 or more, the polyurethane resin prepared from the polyester polyol has satisfactory physical properties, and when the molecular weight of the polyester polyol is not more than about 5,000, its viscosity does not become too high, and handling is easier.

Polyester polyols can be prepared by combining a lactone, and a polyol, and a catalyst and heating it under a controlled atmosphere with stirring, washing the product with a solvent, filtering the mixture and concentrating the solution under reduced pressure to provide the polyester polyol in high yield.

Polyester polyols can be formed by the catalytic reaction of one or more lactones such as EtVP, DEtP, or DVP with one or more polyols with or without a solvent. In some embodiments the lactone, the polyol, and the catalyst are mixed in a vessel and permitted to stir under an inert atmosphere, e.g. N₂, CO₂, He, Ar, etc., for at least 1, 4, 8, 12, 16 or 20 hours, or from 1 to 48, 4 to 36, 8 to 24, or 12 to 20 hours, or less than 100, 72, 48, 36, 24, or 16 hours. The ratio of lactone to polyol can be at least 5, 10, 20, 30, 35, 40, 50, or 70 to one, or from 5 to 100, 20 to 70, or 30 to 40 to one, or less than 200, 100, 70, or 50 to one. The crude product mixture is diluted in a solvent, filtered, and the solvent and any unreacted lactone is removed in vacuo to provide the polyester polyol. The catalyst can be a weak base such as potassium bis(trimethylsilyl)amide or 1,5,7-triazabicyclo[4.4.0]dec-5-ene, but not limited to these.

The lactone may comprise (but is not limited to) a lactone selected from the group comprising: 3-ethyl-6-vinyltetrahydro-2H-pyran-2-one (EtVP), 3,6-diethyltetrahydro-2H-pyran-2-one (DEtP), 3,6,divinyltetrahydro-2H-pyran-2-one (DVP), ε-caprolactone, 4-methylcaprolactone, 3,5,5-trimethylcaprolactone, 3,3,5-trimethylcaprolactone, ~-propiolactone, y-butyrolactone, 5-valerolactone, y-valerolactone, and enanthlactam, or some mixture thereof.

The polyol used in the preparation of the polyester polyol may be (but is not limited to) selected from the group comprising: diols, triols, or higher polyols, polyoxyalkylene polyols, alkylene polyols, 1,2-ethanediol (ethylene glycol), 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethylpropane-1,3-diol, 2-methyl-2,4-pentane dial, 2-ethyl-1,3-hexane dial, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclo-hexanedimethanol, 1,4-cyclohexanedimethanol, 1,4-cyclohexanediethanol, isosorbide, glycerol monoesters, glycerol monoethers, trimethylolpropane monoesters, trimethylolpropane monoethers, pentaerythritol diesters, pentaerythritol diethers, and alkoxylated derivatives of any of these, or aromatic polyols such as hydroquinone, catechol (1,2-dihydroxybenzene), or resorcinol (1,3-dihydroxybenzene), or renewable polyols such as sugars, or some mixture thereof.

The ratio of lactone monomer to hydroxyl groups (OH) on the polyol is at least 5, 10, 15, 20, 25, 30, 35, 40, or 50 to one, or from 5 to 100, 15 to 80, 20 to 50, or 25 to 35 to one, or no more than 20, 25, 30, 35, 40, 50, or 80 to one.

The catalyst for the polyester polyol production reaction is chosen from supramolecular catalysts commonly applied in organocatalytic ring-opening polymerization, including: conjoined thioureaamine (TU/A); (−)-sparteine; tris[2-(dimethylamino)ethyl]-amine (Me6TREN); thiourea cocatalyst sulfonamide; amide; fluorinated alcohol; phenol, or base catalysts including: 4-dimethylaminopyridine, 1,8-diazabicyclo[5.4.0]undec-7-ene (DBU); 7-methyl-1,5,7-triazabicyclo[4.4.0]dec-5-ene (MTBD); 1,5,7-triazabicyclo[4.4.0]dec-5-ene (TBD); a N-heterocyclic carbene, a phosphine, a phosphazene base, or an acidic catalyst chosen from among methane- and trifluoromethane-sulfonic acid (MsOH and TfOH); diphenyl phosphate (DPP); phosphoramidic acid. The lactone to catalyst molar ratio can be at least 10, 20, 30, 40, 50, 60, 80, 100, or 150 to one, or from 10 to 200, 20 to 100, 30 to 60 to one, or not more than 20, 30, 60, 80, 100, or 200 to one.

The solvent to dilute the reaction mixture can be any polar, aprotic solvent such as ethers, ketones, or esters, or one chosen from among diethyl ether, methyl-t-butyl ether (MTBE), ethyl-t-butyl ether (ETBE), THF,

An optional crosslinking agent can be used in the polyester polyol synthesis. Hydroxyalkanoates or polyhydroxyalkanoates which can be used in forming the crosslinking agent in this respect can have the following formula:

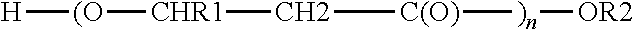

wherein for the hydroxyalkanoate ester, for instance, n=1, R1═OR, where R is H, methyl, ethyl, propyl, butyl, pentyl, hexyl, octyl, or decyl, and R2=methyl, ethyl, propyl, isopropyl, butyl, isobutyl, pentyl, hexyl, or 2 ethyl hexyl; wherein for the hydroxyalkanoate oligomer, for instance, n=2 to about 20, R1═OR, where R2 is H, methyl, ethyl, propyl, butyl, pentyl, hexyl, octyl, or decyl; wherein for the hydroxyalkanoate polymer, for instance, n=21 to about 1000 or more, R1═OR, where R2 is H, methyl, ethyl, propyl, butyl, pentyl, hexyl, octyl, or decyl. In each case above for the oligomer or polymer, for instance, R2=ester or OH, such as a free acid or alkali/alkaline earth cation, such as sodium, potassium, or calcium.

### Polyester Polyols

The molecular weight distribution (Dispersity) of the polyester polyols produced by the reaction as measured by GPC (gel permeation chromatography) is preferably no more than 4.0, 3.0, 2.0, 1.5, 1.3, or 1.2, or from 1.0 to 4.0, 1.0 to 3.0, 1.0 to 2.0, 1.0 to 1.5, 1.0 to 1.3, or from 1.0 to 1.2. When the molecular weight distribution is 1.2 or more, the economy of the production is enhanced, whereas when it is not more than 4.0, physical properties of the polyurethane resin can be enhanced.

Polyester polyol chains can have an Mn less than about 40,000, 35,000, 30,000, 25,000, 10,000, or 5,000 g/mol. In certain embodiments, polyester polyol chains have an Mn between 500 and 40,000, 500 and 30,000, 500 and 15,000, 500 and 10,000, 500 and 5,000, 500 and 3,000, 500 and 2,500, 500 and 2,000, 500 and 1,500, 500 and 1,000, 1,000 and 5,000, 1,000 and 3,000, or between 5,000 and 10,000 g/mol. In certain embodiments, polyester polyol chains have an Mn of about 30,000, 28,000, 25,000, 20,000, 15,000, 10,000, 5,000, 4,000, 3,000, 2,500, 2,000, 1,500, 1,000, 850, 750, or about 500 g/mol.

Additional polyols may be present in the polyol component to which the lactone-derived polyol is added, that can be selected from the group consisting of: polyether polyols, polyester polyols, polybutadiene polyols, polysulfide polyols, natural oil polyols, fluorinated polyols, aliphatic polyols, polyether carbonate polyols, polycarbonate polyols, and mixtures of any two or more these.

Polyester polyols of the present invention may be blended with conventional polymers such as one or more selected from among high density polyethylene (HDPE), low density polyethylene (LDPE), polypropylene, polybutadiene, polyisobutylene, polylactic acid, polystyrene, polyethylene terephthalate (PET), polyvinyl chloride (PVC), or acrylonitrile-butadiene-styrene copolymer (ABS).

### Polyurethane Formation

Polyurethanes can be formed by reacting polyols in a side B mixture with polyisocyanates in a Side A mixture. A process for producing polyurethanes may comprise:
a) providing one or more polyester polyols of Structure (3)

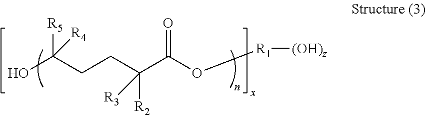

i) wherein: R1 is selected from alkyl or aryl,
ii) n is selected from 1-1,000,
iii) x is selected independently from 2-10, and
iv) z is selected from 0 to 20;
b) reacting the polyester polyol(s) with one or more polyisocyanates to form one or more polyurethanes, and
c) recovering the polyurethanes.

Preferably at least 50, 60, 70, 80, 90, or 99% b/w, or between 50 and 99.9% b/w of the total weight of polyol present in the polyol component (i.e., exclusive of any other non-polyol components that may be present in a Side B composition for foams such as catalysts, cell openers, blowing agents, stabilizers, diluents, pigments and the like) comprises a polyester of Structure (2), and the balance may comprise one or more polyols selected from the group consisting of polyether polyols, polyester polyols, polybutadiene polyols, polysulfide polyols, natural oil polyols, fluorinated polyols, aliphatic polyols, polycarbonate polyols, and mixtures of any two or more these. In some embodiments, the other polyol present in the polyol component to which the polyester polyol is added substantially comprises polyether polyol. In some embodiments, the other polyols present in the polyol component to which the polyester polyol is added substantially comprise a mixture of polyether and polyester polyols.

Side B mixtures of the present invention may include one or more small molecules reactive toward isocyanates. Reactive small molecules included in the inventive Side B mixtures may comprise organic molecules having one or more functional groups selected from the group consisting of alcohols, amines, carboxylic acids, thiols, and combinations of any two or more of these. A non-polymeric small molecule has a molecular weight less than 1,000 g/mol, or less than 1,500 g/mol.

The polyester polyol may comprise a pendent olefin. For example, the polyester polyol is derived from EtVP. In some embodiments, the pendent olefin is used for crosslinking the polyester. In some embodiments, the pendent olefin is used for modifying the polyester. In some embodiments, the method further includes crosslinking the polyester through the pendent olefin to yield a modified polyester. Crosslinking the polymer through the pendent olefin may comprise reacting the pendent olefin with a multi-mercapto coupling agent. The method may further include modifying the pendent olefin with a thiol-ene click reaction, by reacting the olefin moiety with a thiol to form a thioether. A pendant olefin can be modified with the thiol-ene click reaction in the presence of a carboxylic acid or a tertiary amine. The pendant olefin can be metathesized by reaction with another olefin to introduce additional functionality to the polyester polyol. A pendant olefin can be modified by reaction with a 1,3-diene in a Diels-Alder reaction.

The crosslinking density can be controlled by varying the functionality of the polyisocyanate, i.e., the number of isocyanate moeities on a polyisocyanate, the molar ratio of the polyisocyanate to the polyol resin, or by additional use of monofunctional compounds reactive toward isocyanate groups, such as monohydric alcohols, e.g., ethylhexanol or propylheptanol, or some combination of these. The crosslinker can be an isocyanate with a functionality of at least 3. A crosslinker can be used in an amount which corresponds to an NCO:OH equivalents ratio of at least 1, 1.2, 1.5, 2.0, 2.3, 2.5, 3.0, or 4.0, or from 0.5 to 5.0, 0.75 to 4.0, 0.8 to 3.0, 1.0 to 2.5, or 1.2 to 2.3.

### Polyisocyanates

The isocyanate containing material can typically be a polyisocyanate. Preferably, the isocyanate containing material contains at least two isocyanate groups per molecule. The polyisocyanates can be modified or unmodified versions.

The polyisocyanate can be chosen from among diethylbenzene diisocyanate, 2,4- or 2,6-tolylene diisocyanate, m-xylylene diisocyanate, 4,4′-diphenylmethane diisocyanate (MDI), p-phenylene diisocyanate, 1,5-naphthalene diisocyanate, dianisidine diisocyanate, tolidine diisocyanate, a,a,a′,a′-tetramethylxylylene diisocyanate, tetrahydronaphthalene-1,5 diisocyanate, and bis(4-isocyanatophenyl) methane, methylene diisocyanate, propylene diisocyanate: tetramethylene diisocyanate, pentamethylene diisocyanate, hexamethylene diisocyanate, decamethylene 1,10-diisocyanate, cyclohexylene 1,2-diisocyanate, lysine diisocyanate, 2,2,4- or 2,4,4-trimethyl hexamethylene diisocyanate, 1,6-hexamethylene diisocyanate, etc., alicyclic diisocyanates such as 1,4-cyclohexane diisocyanate, methylcyclohexane diisocyanate (hydrogenated TDI), 1-isocyanato-3-isocyanatomethyl 1-3,5,5-trimethyl cyclohexane (IPDI), 4,4′-dicyclohexylmethane diisocyanate, isopropylidenedicyclohexyl-4,4′-diisocyanate, isophorone diisocyanate, or other aromatic polyisocyanates, aliphatic polyisocyanates, aromatic ring-containing aliphatic diisocyanates, isocyanurates (cyclic trimers of isocyanates), and the like.

### Polyurethanes

The art of polyurethane synthesis is very advanced and a large number of isocyanates and related polyurethane precursors are known in the art and available commercially. It is to be understood that it is within the capabilities of one skilled in the art of polyurethane formulation to select and use such isocyanates along with the teachings of this disclosure to produce polyurethane compositions within the scope of the present invention. Polyurethanes of the present invention are generally prepared from two components, a Side A component that comprises one or more polyisocyanates and a Side B component that comprises one or more polyester polyols. Catalysts may be included in either the Side A or Side B component.

The polyurethanes of the present invention can be linear or cross-linked. The polyurethanes can be any type of polyurethane such as, but not limited to, castable, millable, thermoplastic, cellular, sprayable, poromeric (e.g., porous), fibrous, and the like.

Various types of polyurethanes can be formed using the components of the present invention along with the knowledge of those skilled in the art with respect to making polyurethanes. For instance, a linear polyurethane is typically prepared by reacting a diol with an aliphatic diisocyanate. Typically, a slight excess of diisocyanate is employed and this enables the crosslinking to occur at the urethane or urea group.

The molar ratio of polyisocyanate to polyester polyol can be from 0.01 to 100, 0.1 to 20, 0.5 to 10, 0.8 to 5, or 0.95 to 1.5 to one, or at least 0.5, 0.8, 1, 2, 5, or 10 to one, or less than 10, 5, 2, 1, 0.8, or 0.5 to one. The molar ratio of isocyanate (—NCO) moieties to hydroxyl (—OH) moieties in the mixture of materials used for polyurethane production can be from 0.5 to 2, 0.7 to 1.5, 0.8 to 1.2, 0.9 to 1.1, or 0.95 to 1.05 to one, or at least 0.7, 0.8, 1, 1.1, 1.2, or 1.3 to one, or less than 2, 1.5, 1.2, 1.1, 0.95, or 0.9 to one.

In preparing the polyurethanes of the present invention, one or more catalysts can be used in the reaction. Conventional catalysts used for the making of polyurethanes can be used in the present invention. In some embodiments, such catalysts may be chosen from among, but are not limited to, tertiary amines, and organometallic compounds. Exemplary tertiary amine compounds include triethylamine, triethylenediamine, N-methylmorpholine, N,N-dimethylcyclohexylamine, pentamethyldiethylenetriamine, tetramethylethylenediamine, I-methyl-4-dimethylaminoethylpiperazine, 3-methoxy-Ndimethylpropylamine, N-ethylmorpholine, diethylethanolamine, N-cocomorpholine, N,N-dimethyl-N′,N′-dimethyl isopropylpropylenediamine, N,N-diethyl-3-di-ethylaminopropylamine dimethylbenzy !amine, 1,8-Diazabicycloundec-7-ene (DBU), 1,4-diazabicyclo[2.2.2]octane (DABCO) triazabicyclodecene (TBD), and N-methyltriazabicyclodecene (MTBD). Exemplary organometallic catalysts include organomercury, organ lead, organ ferric and organotin catalysts, with organotin catalysts being preferred among these. Suitable tin catalysts include stannous chloride, tin salts of carboxylic acids, dibutyltin dilaurate, dibutylbis(arylthio) stannate, dibutyltinbis(isooctylmercapto acetate) and dibutyltinbis(isooctylmaleate), tin octanoate, alkyl tin carboxylates, and mixtures of any two or more of these as well as other organometallic compounds such as organometallic compounds based on mercury, lead, bismuth (bismuth octanoate), and/or zinc. Specific examples include mercury carboxylates, such as phenylmercuric neodecanoate, oxides and mercaptides oxides, for example, dibutyltin dilaurate, dioctyl tin mercaptide, or dibutyl tin oxide, tin mercaptides. are disclosed in U.S. Pat. No. 2,846,408 and elsewhere. A catalyst for the trimerization of polyisocyanates, resulting in a polyisocyanurate, such as an alkali metal alkoxide may also optionally be employed herein.

Furthermore, catalysts can be chosen based on whether they favor the urethane (gel) reaction, such as 1,4-diazabicyclo[2.2.2]octane (also called DABCO or TEDA), or the urea (blow) reaction, such as bis-(2-dimethylaminoethyl) ether, or specifically drive the isocyanate trimerization reaction, such as potassium octanoate. Catalysts may be included in the Side B component.

In certain embodiments, a polymerization reaction is allowed to proceed until the number average molecular weight of the polymers formed is between about 500 and about 400,000, 500 and 40,000, 500 and 20,000, 500 and 10,000, 500 and 5,000, 500 and 2,500, or 1,000 and 5,000 g/mol.

The Side A component and Side B component can be fed as separate streams that are brought together and mixed in a nozzle or dispersing device as they are fed into a mold or hollow space to form a foam. One or more blowing agents can additionally be used in the formation of the polyurethanes, if desired. Blowing agents activated chemically or by mechanical means can be used in the present invention. Conventional blowing agents can be used, such as water and low-boiling inert liquids, such as hydrocarbons. Preferably, the blowing agent is a pentane such as a cyclopentane or can be combinations of various blowing agents. The blowing agent can be used in conventional amounts. In preparing the polyurethanes of the present invention, the reactants can simply be mixed together under ambient conditions with low shear or high shear mixing. The reaction can occur in minutes or in hours depending on temperature and the optional use of catalyst.

A method may comprise adding CO₂ or other gas as a separate feed stream at the point where a Side A composition and a Side B composition are mixed. In other embodiments, a method comprises adding liquid CO₂ as a separate feed stream to the mixture of a Side A composition and Side B composition (i.e., the CO₂ is added at a point after the mixing of the Side A and Side B). The step of adding CO₂ may comprise feeding a liquid CO₂ stream. The step of adding a gas may comprise feeding CO₂ or other gas as a compressed gas stream.

### Polyurethanes

Polyurethanes of the present invention may comprise the products of reaction between materials of Structure (3) and one or more polyisocyanates.

Other additives customary to polyurethane formulations can be used in the present invention including, but not limited to, chain-extenders, for example 1,4-butanediol or hydrazine, catalysts, for example tertiary amines or tin compounds, surfactants, for example siloxane-oxyalkylene copolymers, blowing agents, for example water and trichlorofluoromethane, cross-linking agents, for example triethanolamine, fillers, pigments, fire retardants, foam stabilizers, antioxidants, and the like. The reaction conditions and various components and amounts that can be present in the present invention are described in U.S. Pat. Nos. 6,087,466; 6,087,410; 6,043,292; 6,034,149; and 6,087,409, all of which are incorporated in their entirety by reference.

The weight average molecular weight of the polyurethane can be any molecular weight and depends upon the products used to form the polyurethane. The weight average molecular weight of the polyurethane by means of GPC measurement can be from 10,000 to 1,000,000, 20,000 to about 200,000 g/mol, 30,000 to 150,000, preferably from 50,000 to 500,000, more preferably from 100,000 to 400,000, and most preferably from 100,000 to 300,000 in terms of a polyurethane polymerization solution. A molecular weight distribution is preferably from 1.5 to 3.5, more preferably from 1.8 to 2.5, and still more preferably from 1.9 to 2.3 in terms of Mw/Mn.

U.S. Pat. No. 10,619,000

The polyurethanes of the present invention can have a storage modulus that is at least 5, 10, 50, 100, 250, 300, or 500 times greater at 60° C. than at 160° C., or from 5 to 1000, 10 to 550, 50 to 250, or 75 to 200 times greater at 60° C. than at 160° C., or less than 10, 50, 100, 250, 300, 600, or 1000 times greater at 60° C. than at 160° C. The polyurethanes of the present invention can have a loss modulus that is at least 5, 10, 25, 40, 60, 80, or 90 times greater at 60° C. than at 160° C., or from 1 to 200, 5 to 120, 10 to 100, or 60 to 95 times greater at 60° C. than at 160° C., or less than 200, 120, 100, 75, 50, 25, or 15 times greater at 60° C. than at 160° C.

The polyurethane(s) can be blended, either during or after polyurethane synthesis, with other polymers selected from among polyethylene, polypropylene, polyesters, polyethylene terephthalate (PET), acrylonitrile-butadiene-styrene (ABS) copolymers, polyamide, polyethers, polycarbonates, poly(oxides), poly(sulfides), polyarylates, polyetherketones, polyetherimides, polysulfones, polyvinyl alcohols, and polymers produced by polymerization of monomers, such as, for example, dienes, olefins, styrenes, acrylates, acrylonitrile, methacrylates, methacrylonitrile, diacids and diols, lactones, diacids and diamines, lactams, vinyl esters, block copolymers thereof, and alloys thereof; thermoset polymers such as, for example, epoxy resins; phenolic resins; melamine resins; alkyd resins; vinyl ester resins; unsaturated polyester resins; crosslinked polyurethanes; polyisocyanurates; crosslinked elastomers, including but not limited to, polyisoprene, polybutadiene, styrene-butadiene, styrene-isoprene, ethylene-propylene-diene monomer polymer; or some combination thereof. The polyurethanes of the present invention may comprise at least 10, 20, 30, 40, 50, 60, 70, 80, 90, 95, or 99% by weight of the blended polymer.

### Products/Applications

The polyurethanes of the present invention can have a variety of different properties, and some of these are tunable to fit different applications. The polyurethanes can be biodegradable and can be recycled. Further, the polyurethane can be used in numerous applications, including, but not limited to, coatings, sealants, binder in an ink jet ink, foams (including rigid and flexible), polyisocyanurate foams, elastomers, dispersions, and other water dispersible applications. The polyurethane can be formed into various articles, such as pipes, insulation, and any other articles traditionally formed from polyurethane materials such as adhesives, surfactants, thermoplastic elastomers, insulating panels such as refrigerators or coolers, flexible foams, mattresses, sofas, armchairs, shoes, synthetic leather, car seats, dash boards, sound insulation, or shock protection, or other automobile components, and the like.

The polyurethane materials can be utilized as a thermal insulating polishing pad in a chemical-mechanical polishing (CMP) process in the production of semiconductor wafers. The polishing pad sits between the semiconductor wafer and the platen that is cooled to remove heat produced by the polishing. The polyurethanes are particularly effective as polishing pads because of their highly adjustable storage modulus which indicates the ability to absorb energy while resisting distortion, and yet their heat transfer can be adjusted by the optional inclusion of high thermal conductivity materials such as diamond particles, carbon nanotube particles, highly thermally conductive metal particles such as Ag, Cu, or Au which may be used in the slurry of polyurethane. The diamond particles, carbon nanotube, or metal particles may be hard, may have a high heat transfer coefficient, and may be chemically stable. The heat transfer materials may be included in the polishing pad and thus a heat transfer path that penetrates the polishing pad may be formed that allows the heat to move from the region where the semiconductor wafer and the polishing pad contact each other to the platen which is cooled.

These various applications can be accomplished using conventional techniques known to those skilled in the art in view of the present application.

### Examples

### Example 1: Polyester Polyol Synthesis

In an N2 purged glovebox, 3-ethyl-6-vinyltetrahydro-2H-pyran-2-one (EtVP) (6.0 g, 39 mmol) was added into a 20 mL vial with a magnetic stir bar and followed by 1,4-butanediol (0.58 g 0.65 mmol) and 1,5,7-triazabicyclo[4.4.0]dec-5-ene (0.14 g, 0.98 mmol). The vial was allowed to stir under N2 atmosphere for 24 hours. The polyol product was diluted with methyl tert-butyl ether (10 mL) and passed through silica gel plug. The mixture was concentrated under reduced pressure to yield 4.4 g (73% yield) of a viscous and colorless oil. By ¹H NMR end group analysis, Mn was calculated to be 2650 g/mol.

This example demonstrates that polyester polyols can be made in high yield from EtVP and a polyol.

### Example 2: Polyester Polyol Synthesis

In an N₂ purged glovebox, 3-ethyl-6-vinyltetrahydro-2H-pyran-2-one (EtVP) (6.0 g, 39 mmol) was added into a 20 mL vial with a magnetic stir bar and followed by 1,4-butanediol (0.35 g 3.9 mmol) and 1,5,7-triazabicyclo[4.4.0]dec-5-ene (0.14 g, 0.98 mmol). The vial was allowed to stir under N2 atmosphere for 24 hours. The polyol product was diluted with methyl tert-butyl ether (10 mL) and passed through silica gel plug. The mixture was concentrated under reduced pressure to yield 4.5 g (75% yield) of a viscous and colorless oil. By ¹H NMR end group analysis, Mn was calculated to be 873 g/mol.

This example demonstrates that polyester polyols can be made in high yield from EtVP and a polyol

### Example 3: Polyester Polyol Synthesis

In an N₂ purged glovebox, 3-ethyl-6-vinyltetrahydro-2H-pyran-2-one (EtVP) (4.0 g, 26 mmol) was added into a 20 mL vial with a magnetic stir bar and followed by 1,4-benzenedimethanol (0.041 g 0.30 mmol) and 1,5,7-triazabicyclo[4.4.0]dec-5-ene (0.18 g, 1.3 mmol). The vial was allowed to stir under N2 atmosphere for 24 hours. The polyol product was diluted with methyl tert-butyl ether (10 mL) and passed through silica gel plug. The mixture was concentrated under reduced pressure to yield 2.5 g (63% yield) of a viscous and colorless oil. By 1H NMR end group analysis, Mn was calculated to be 6090 g/mol.

This example demonstrates that aryl diols can be used to produce polyols from EtVP.

### Example 4: Polyester Polyol Synthesis

In an N₂ purged glovebox, 3,6-diethyltetrahydro-2H-pyran-2-one (DEtP) (11.7 g, 75 mmol) was added into a 100 mL round-bottom flask with a magnetic stir bar and followed by 1,4-butanediol (0.685 g 7.6 mmol) and N-cyclohexyl-N′-phenyl-urea (0.164 g, 0.75 mmol) and potassium bis(trimethylsilyl)amide (0.15 g, 0.75 mmol). The round-bottom flask was allowed to stir under N2 atmosphere for 6 hours. Benzoic acid (0.098 g, 0.80 mmol) was added to the mixture. The mixture was diluted with 80 mL of chloroform and passed through silica gel plug. The mixture was concentrated under reduced pressure to remove chloroform and the concentrated oil was subjected to a vacuum distillation to yield 8.5 g (73% yield) of a viscous and colorless oil. By 1H NMR end group analysis, Mn was calculated to be 1560 g/mol.

### Example 5: Polyester Polyol Synthesis

In an N₂ purged glovebox, 3,6-diethyltetrahydro-2H-pyran-2-one (DEtP) (4 g, 25.6 mmol) was added into a 20 mL vial with a magnetic stir bar and followed by 1,4-benzenedimethanol (0.0141 g 0.102 mmol) and N-cyclohexyl-N′-phenyl-urea (0.0559 g, 0.256 mmol) and potassium bis(trimethylsilyl)amide (0.0511 g, 0.256 mmol). The round-bottom flask was allowed to stir under N2 atmosphere for 6 hours. Benzoic acid (0.098 g, 0.80 mmol) was added to the mixture. The mixture was diluted with 15 mL of chloroform and passed through silica gel plug. The mixture was concentrated under reduced pressure to remove chloroform and the concentrated oil was subjected to a vacuum distillation to yield 2.6 g (65% yield) of a viscous, colorless oil. By 1H NMR end group analysis, Mn was calculated to be 28,100 g/mol.

This example shows that high molecular weight polyester polyols can be produced by the inventive method. This example shows that polyester polyols can be produced by the reaction of a fully hydrogenated lactone, 3,6-diethyltetrahydro-2H-pyran-2-one (DEtP), with a polyol.

### Example 6: Polyurethane Synthesis

The polyester polyol from Example 1 (1.5 g) is charged to a 10 mL beaker, followed by 1,6-hexamethylene diisocyanate (0.075 g, 0.45 mmol). The mixture is heated at 70° C. and stirred with overhead mechanical stirring (300 rpm) for 10 mins to ensure all of the isocyanate is dissolved. Tin octanoate, Sn(Oct)₂ (0.02 mL), is added to the mixture. The overall reaction is kept under stirring at 70° C. for 2 hour to achieve a solid polyurethane material without further purification.

This example shows that polyurethanes can be produced in high yield from the reaction of the polyester polyols of the present invention with alkyl polyisocyanates.

### Example 7: Polyurethane Synthesis

The polyester polyol from Example 2 (1.5 g) is charged to a 10 mL beaker, followed by 4,4′-diphenylmethane diisocyanate (0.86 g, 3.4 mmol) 1,4-butanediol (0.16 g, 1.8 mmol). The mixture is heated at 70° C. and stirred with overhead mechanical stirring (300 rpm) for 10 mins to make ensure the isocyanate is dissolved. Tin octanoate Sn(Oct)₂ (0.04 mL) is added to the mixture. The overall reaction is kept under stirring at 70° C. for 30 mins to achieve a solid polyurethane material without further purification.

This example shows that polyurethanes can be produced in high yield from the reaction of the polyester polyols of the present invention with aryl polyisocyanates and diols.

### Example 8: Polyurethane Synthesis

The polyester polyol from Example 3 (1.99 g) is charged to a 20 mL reactor, followed by 1,6-hexamethylene diisocyanate (0.53 g, 3.2 mmol) and 1,4-butanediol (0.11 g, 1.2 mmol). The mixture is heated at 70° C. and stirred with overhead mechanical stirring (300 rpm) for 10 mins. Sn(Oct)₂ (0.3 mL) is added to the mixture. The overall reaction is kept under stirring at 70° C. for 4.5 hours to achieve a solid polyurethane material without further purification.

This example shows that polyurethanes can be produced in high yield from the reaction of the polyester polyols of the present invention with alkyl polyisocyanates and diols.

### Example 9: Depolymerization Test

The material from Example 7 (0.1 g) was added to a 20 mL vial followed by Ti(nBuOt)₄ (0.011 g) with a stir bar. The mixture was heated for 24 hours at 100° C. under reduced pressure to collect the lactone by distillation (0.072 g, 72% yield). Structure confirmed by ¹H NMR to match 3-ethyl-6-vinyltetrahydro-2H-pyran-2-one (EtVP).

This example shows that the polyurethanes of the present invention can be readily converted back into their constituent parts and the lactone isolated from the mixture in high yield.

### Example 10: Rheology Data

To establish the properties of the polymers rheology tests were performed using a rheometer in a range of 25-180° C. The data are collected in the Table. Ratios of the storage modulus at 60 to the storage modulus at 160, the loss modulus at 60 to the loss modulus at 160, the loss modulus to the storage modulus at 60, and the loss modulus to the storage modulus at 160 are presented in the Table.

TABLE
Modulus Measurements for Different Materials
at Different Temperatures.

| | Storage | Loss | Storage | Loss |
|---|---|---|---|---|
| | modulus at | modulus at | modulus at | modulus at |
| | 60° C. (Pa) | 60° C. (Pa) | 160° C. (Pa) | 160° C. (Pa) |
| Example 6 | 20,000 | 9,400 | 1,900 | 670 |
| Example 7 | 590,000 | 120,000 | 2,200 | 1,800 |
| Example 8 | 710,000 | 26,000 | 1,300 | 280 |

The results in the above Table show that the storage modulus of the polyurethanes of the present invention at 60° C. can be adjusted over a range of more than 35X while the storage modulus at 160° C. for the same materials are within a factor of 2X of each other. The results in the Table also demonstrate that materials of the present invention can be made with a storage modulus which is from 10× to almost 550× higher at 60° C. than at 160° C.

TABLE
Ratios of Modulus Measurements for Different
Materials at Different Temperatures.

| | Storage | Loss | | |
|---|---|---|---|---|
| | Modulus | Modulus | Loss/Storage | Loss/Storage |
| | 160° C./60° C. | 160° C./60° C. | 60° C. | 160° C. |
| Example 6 | 10.5 | 14.0 | 0.47 | 0.35 |
| Example 7 | 268.2 | 66.7 | 0.20 | 0.82 |
| Example 8 | 546.2 | 92.9 | 0.04 | 0.22 |

The results in the above Table demonstrate that the ratios of the storage modulus at 160 to the storage modulus at 60 range from 10 to nearly 550, the ratio of the loss modulus at 160 to the loss modulus at 60 range from 14 to almost 100, the ratio of the loss modulus to the storage modulus at 60° C. range from 0.04 to nearly 0.50, and the ratio of the loss modulus to the storage modulus at 160° C. range from 0.22 to nearly 0.82. These results show the very substantial range over which the properties of the polyurethanes can be tuned by choice of composition.

If desired, the polyurethane compositions described herein may be further functionalized to form radiation-curable derivatives. For example, an isocyanate-terminated polyurethane prepared from the polyester polyols disclosed herein may be reacted with a hydroxyl-functional (meth)acrylate to introduce polymerizable unsaturated end groups. The resulting polyurethane (meth)acrylate may be cured by ultraviolet radiation, electron-beam radiation, or other suitable means, optionally in the presence of a photoinitiator, to form crosslinked polymer networks suitable for coatings, adhesives, or related applications.

1-118. (canceled)

119. A polyurethane composition comprising the reaction product of:
a) one or more polyisocyanates; and b) a polyester polyol having a structure according to Structure (3): 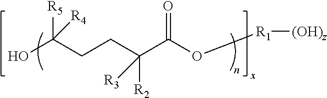
wherein R1 is selected from alkyl or aryl groups; wherein R2, R3, R4, and R5 are independently selected from H, alkyl, alkenyl, or aryl functional groups; wherein x is from 2 to 10; wherein z is from 0 to 20; and wherein n is from 1 to 1,000.

120. The polyurethane composition of claim 119, wherein at least one of the lactone units in the polyester polyol is prepared from the reaction of one or more 1,3-dienes with C02.

121. The polyurethane composition of claim 119, wherein the one or more lactones are selected from 3-ethyl-6-vinyltetrahydro-2H-pyran-2-one (EtVP), 3,6-diethyltetrahydro-2H-pyran-2-one (DEtP), or 3,6-divinyltetrahydro-2H-pyran-2-one (DVP), or a combination thereof.

122. The polyurethane composition of claim 119, wherein the polyester polyol is prepared from a lactone selected from 3-ethyl-6-vinyltetrahydro-2H-pyran-2-one (EtVP); wherein the mass ratio of EtVP to other lactones is at least 20:1.

123. The polyurethane composition of claim 119, wherein the polyester polyol comprises pendent olefin groups, or wherein said pendent olefin groups are reacted with a multi-mercapto coupling agent, a thiol-ene click reagent, or an olefin metathesis catalyst to form a crosslinked or functionalized network.

124. The polyurethane composition of claim 119, having a loss modulus at 60° C. that is at least 5, 10, 25, 40, 60, 80, or 90 times greater than the loss modulus at 160° C.; or wherein the ratio of the loss modulus at 60° C. to the loss modulus at 160° C. is from 1 to 200, 5 to 120, 10 to 100, or 60 to 95; or wherein said ratio is less than 200, 120, 100, 75, 50, 25, or 15.

125. The polyurethane composition of claim 119, having a storage modulus ranging from 100 Pa to 1,000,000 Pa over the temperature range of 0° C. to 200° C.; wherein the storage modulus at 80° C. is from 100,000 to 5,000,000 Pa, 150,000 to 4,000,000 Pa, or 250,000 to 3,000,000 Pa; or is at least 50,000, 100,000, 500,000, 1,000,000, 2,500,000, or 4,000,000 Pa; and
wherein the storage modulus at 160° C. is from 200 to 10,000 Pa, 200 to 5,000 Pa, or 500 to 2,500 Pa; or is at least 100, 200, 400, 500, 1,000, 2,500, or 5,000 Pa; or is less than 20,000, 10,000, 5,000, 2,500, 1,000, 500, or 200 Pa.

126. The polyurethane composition of claim 119, wherein R1 is an organic moiety derived from an initiator selected from the group consisting of:
monoalcohols, diols, triols, higher polyols, polyoxyalkylene polyols, alkylene polyols, 1,2-ethanediol (ethylene glycol), 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethylpropane-1,3-diol, 2-methyl-2,4-pentanediol, 2-ethyl-1,3-hexanediol, 2-methyl-1,3-propanediol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, glycerol, glycerol monoesters, glycerol monoethers, trimethylolpropane monoesters, trimethylolpropane monoethers, pentaerythritol, pentaerythritol diesters, pentaerythritol diethers, alkoxylated derivatives thereof, aromatic polyols, hydroquinone, catechol (1,2-dihydroxybenzene), resorcinol (1,3-dihydroxybenzene), renewable polyols, sugars, and combinations thereof.

127. The polyurethane composition of claim 119, wherein the polyurethane composition comprises less than 0.1% by weight of the sum of residual solvent and monomer, and optionally further comprises one or more blended polymers selected from the group consisting of: polyether polyols, polyester polyols, polycarbonate polyols, polyethylene, polypropylene, polyethylene terephthalate (PET), acrylonitrile-butadiene-styrene (ABS), polyamide, polycarbonates, epoxy resins, phenolic resins, and mixtures thereof.

128. The polyurethane composition of claim 119, wherein the one or more polyisocyanates are selected from the group consisting of:
diethylbenzene diisocyanate, 2,4- or 2,6-tolylene diisocyanate (TDI), m-xylylene diisocyanate, 4,4′-diphenylmethane diisocyanate (MDI), p-phenylene diisocyanate, 1,5-naphthalene diisocyanate, dianisidine diisocyanate, tolidine diisocyanate, a,a,a′,a′-tetramethylxylylene diisocyanate, tetrahydronaphthalene-1,5 diisocyanate, bis(4-isocyanatophenyl) methane, methylene diisocyanate, propylene diisocyanate, tetramethylene diisocyanate, pentamethylene diisocyanate, hexamethylene diisocyanate, decamethylene 1,10-diisocyanate, cyclohexylene 1,2-diisocyanate, lysine diisocyanate, 2,2,4- or 2,4,4-trimethyl hexamethylene diisocyanate, 1,4-cyclohexane diisocyanate, methylcyclohexane diisocyanate (hydrogenated TDI), 1-isocyanato-3-isocyanatomethyl-3,5,5-trimethyl cyclohexane (IPDI), 4,4′-dicyclohexylmethane diisocyanate, isopropylidenedicyclohexyl-4,4′-diisocyanate, isophorone diisocyanate, aromatic polyisocyanates, aliphatic polyisocyanates, aromatic ring-containing aliphatic diisocyanates, and combinations thereof.

129. The polyurethane composition of claim 119, wherein the one or more lactones are prepared from the reaction of bio-based 1,3-butadiene and C02, wherein the C02 is recovered from ammonia production, fermentation, anaerobic digestion, cement manufacture, waste incineration flue gas, direct air capture, or a combination thereof.

130. The polyurethane composition of claim 119, wherein the polyester polyol has a number average molecular weight (Mn) of from 500 to 10,000 g/mol, or from 1,000 to 5,000 g/mol.

131. A process for producing polyurethanes comprising:
a) providing one or more lactones of Structure (2): 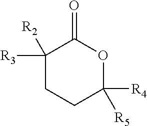
wherein R2, R3, R4, and R5 are independently selected from H, alkyl, alkenyl, vinylidenyl, or aryl functional groups, and wherein the one or more lactones are prepared from the reaction of one or more 1,3-dienes with C02; b) reacting the one or more lactones with one or more polyols to form one or more polyester polyol(s); c) reacting the one or more polyester polyol(s) with one or more polyisocyanates to form one or more polyurethanes; and d) recovering the polyurethanes.

132. The process of claim 131, wherein step b) is conducted at a temperature of from −20 to 80° C.

133. The process of claim 131, wherein step b) is conducted in the presence of a base, and optionally, a catalyst;
wherein the base is selected from the group consisting of: anionic bases, hydroxides, alkali metal amides, alkali metal alkoxides (such as potassium tert-butoxide), potassium bis(trimethylsilyl)amide (KIMIDS), and 1,5,7-triazabicyclo[4.4.0]dec-5-ene (TBD); and wherein the optional catalyst is selected from the group consisting of: (a) nucleophilic catalysts selected from 4-dimethylaminopyridine (DMAP), phosphines, ureas, thioureas, or N-heterocyclic carbenes; (b) tertiary amine compounds selected from triethylamine, triethylenediamine, N-methylmorpholine, N,N-dimethylcyclohexylamine, pentamethyldiethylenetriamine, tetramethylethylenediamine, 1-methyl-4-dimethylaminoethylpiperazine, 3-methoxy-N-dimethylpropylamine, N-ethylmorpholine, diethylethanolamine, N-cocomorpholine, N,N-dimethyl-N′,N′-dimethyl isopropylpropylenediamine, N,N-diethyl-3-di-ethyl aminopropyl amine dimethyl benzyl amine, 1,8-Diazabicycloundec-7-ene (DBU), 1,4-diazabicyclo[2.2.2]octane (DABCO), and N-methyltriazabicyclodecene (MTBD); (c) organometallic catalysts selected from organomercury, organ lead, organoiron, organotin catalysts, stannous chloride, tin salts of carboxylic acids, dibutyltin dilaurate, dibutylbis(arylthio) stannate,
dibutyltinbis(isooctylmercapto acetate), dibutyltinbis(isooctylmaleate), tin octanoate, alkyl tin carboxylates, bismuth octanoate, zinc compounds, mercury carboxylates, phenylmercuric neodecanoate, dibutyltin dilaurate, dioctyl tin mercaptide, dibutyl tin oxide, tin mercaptides; and
combinations thereof.

134. The process of claim 131, wherein step b) is optionally conducted in the presence of a solvent, wherein said solvent is selected from the group consisting of: dichloromethane, chloroform, tetrahydrofuran (THF), methyl-tert-butyl ether, diethyl ether, toluene, benzene, dioxane, hexanes, pentane, dimethyl sulfoxide (DMSO), dimethylformamide (DMF), and combinations thereof.

135. The process of claim 131, wherein the molar ratio of isocyanate (—NCO) moieties to hydroxyl (—OH) moieties in step c) is from 0.9 to 1.1 to one.

136. The process of claim 131, wherein the polyester polyol formed in step b) is distilled in vacuo at a pressure of less than 1 torr at a temperature of at least 80° C. to remove solvent and residual monomer.

137. An article comprising the polyurethane composition of any one of claim 119, wherein the article is selected from the group consisting of:
coatings, sealants, binder in an ink jet ink, foams including rigid and flexible foams, polyisocyanurate foams, elastomers, dispersions, water dispersible applications, pipes, insulation, adhesives, surfactants, thermoplastic elastomers, rigid foams, insulating panels, refrigerators or coolers, flexible foams, mattresses, sofas, armchairs, shoes, synthetic leather, car seats, dash boards, sound insulation, shock protection, automobile components, and polishing pads used in chemical-mechanical polishing (CMP) processes.

138. The article of claim 137, wherein the article is footwear, a shoe sole, flexible foam, rigid foam, synthetic leather, an adhesive, a sealant, a coating, or a polishing pad used in chemical-mechanical polishing (CMP) processes.
